(19) United States
(12) Patent Application Publication
(10) Pub. No.: US 2019/0303955 A1
(43) Pub. Date: Oct. 3, 2019

(54) TRAFFICVIEW

(71) Applicant: URBAN SCIENCE APPLICATIONS, INC., Detroit, MI (US)

(72) Inventors: Rick TWYDELL, Northville, MI (US); Mitch PHILLIPS, Novi, MI (US); Randy BERLIN, Canton, MI (US)

(21) Appl. No.: 16/373,406

(22) Filed: Apr. 2, 2019

Related U.S. Application Data
(60) Provisional application No. 62/651,685, filed on Apr. 2, 2018.

(51) Int. Cl. G06Q 30/02; G06Q 30/00

(52) U.S. Cl. CPC G06Q 30/0201; G06Q 30/01

(57) ABSTRACT

Disclosed herein are systems and methods directed toward providing customer relationship management. As discussed herein, an embodiment may obtain remote traffic data for merchant web sites as well as foot traffic data for retail locations, including customer count, virtual sales count, and online customer based data. The data is then analyzed to determine one or more customer relationship management factors. Based on one or more user inputs, the analyzed data may be used to generate a customized user interface that displays a visual representation of the portion of the one or more customer relationship management factors.

### INCORPORATION BY REFERENCE

This application claims priority to U.S. Provisional Patent Application No. 62/651,685, entitled “TRAFFIC VIEW,” filed on Apr. 2, 2018, the entirety of which is hereby incorporated by reference.

### BACKGROUND

As technology grows, the methods for individuals and/or businesses to contact one another continues to increase. Communication between people is easier and faster than ever before. This has led to changes across almost every marketspace in the United States. This ease of communication has created an environment where a consumer can shop at a large number of competing merchants. For example, a consumer can contact merchants supplying a similar, or mostly similar, product in seconds/minutes instead of days using the Internet.

Nowhere is this more apparent than in car shopping. Before the information technology age, the majority of the population would have to physically visit a dealership, or possibly multiple dealerships, and work with one or more sales people to purchase an automobile. However, with the explosion of information on the Internet, consumers are able to search hundreds of car dealer inventories and even see real time pricing of the vehicles listed. This has greatly increased the competition for car dealers and thus most are looking for any competitive edge they can find.

Specifically, a merchant (e.g., a car dealer) may be very interested in their customer relationship management (CRM). CRM is an attempt to manage a company's interaction with current and potential customers. Specifically, a CRM system may use data analysis about customers' history with a business to improve the business' relationships with its customers, specifically focusing on customer retention and ultimately driving sales growth.

Thus, a system is needed to allow merchants to better track their sales and to track such sales in a comprehensive and holistic approach.

### BRIEF DESCRIPTION OF THE DRAWINGS

For the purpose of illustrating the invention, there is shown in the drawings various embodiments, it being understood, however, that the invention is not limited to the specific instrumentalities disclosed as they are used for illustrative purposes only. Included in the drawings are the following Figures:

FIG. 1 depicts an example Summary Screen according to one or more embodiments described herein.

FIG. 2 depicts a continuation of the example Summary Screen from FIG. 1 according to one or more embodiments described herein.

FIG. 3 depicts an example Traffic Source view according to one or more embodiments described herein.

FIG. 4 depicts an example Model (product type) view according to one or more embodiments described herein.

FIG. 5 depicts an example Salespeople view according to one or more embodiments described herein.

FIG. 6 depicts a continuation of the example Salespeople view from FIG. 5 according to one or more embodiments described herein.

FIG. 7 depicts an example Defection Rate Status screen with a trend window according to one or more embodiments described herein.

FIG. 8 depicts an example Defection Rate High Level Summary to display opportunities for improvement according to one or more embodiments described herein.

FIG. 9 depicts an example Days to Sale graph according to one or more embodiments described herein.

FIG. 10 depicts an example All Traffic Volume Trend graph according to one or more embodiments described herein.

FIG. 11 depicts an example report on Traffic and Sales by Traffic Source according to one or more embodiments described herein.

FIG. 12 depicts an example report on Model and Dealer Defections by Traffic Type according to one or more embodiments described herein.

FIG. 13 depicts an example report on Top Defection Opportunities to OEM Third Parties according to one or more embodiments described herein.

FIG. 14 depicts an example graph on Traffic Volume Trends of OEM Third Parties according to one or more embodiments described herein.

FIG. 15 depicts an example graph on Sales Trends of OEM Third Parties according to one or more embodiments described herein.

FIG. 16 depicts an example graph on Defection Rate Trends of OEM Third Parties according to one or more embodiments described herein.

FIG. 17 depicts an example graph on Days to Sale of OEM Third Parties according to one or more embodiments described herein.

FIG. 18 depicts an example report on Traffic and Sales by Requested Model according to one or more embodiments described herein.

FIG. 19 depicts an example report on Top Defection Opportunities for a specific product according to one or more embodiments described herein.

FIG. 20 depicts an example graph on Traffic Volume Trends for a specific product according to one or more embodiments described herein.

FIG. 21 depicts an example graph on Sales Trends for a specific product according to one or more embodiments described herein.

FIG. 22 depicts an example graph on Deflection Rate Trends for a specific product according to one or more embodiments described herein.

FIG. 23 depicts an example graph on Days to Sale for a specific product according to one or more embodiments described herein.

FIG. 24 depicts an example graph on Sales by custom options for a specific product according to one or more embodiments described herein.

FIG. 25 depicts an example report on Traffic and Sales by Salesperson according to one or more embodiments described herein.

FIG. 26 depicts an example report on Traffic Mix by Salesperson according to one or more embodiments.

FIG. 27 depicts an example report summarizing Top Deflection Opportunities according to one or more embodiments described herein.

FIG. 28 depicts an example graph on overall Traffic Volume Trends according to one or more embodiments described herein.

FIG. 29 depicts an example graph on overall Sales Trends according to one or more embodiments described herein.

FIG. 30 depicts an example graph on overall Defection Rate Trends according to one or more embodiments described herein.

FIG. 31 depicts an example graph on overall Days to Sale according to one or more embodiments described herein.

FIG. 32 depicts an example report on Traffic and Sales by according to one or more embodiments described herein.

FIG. 33 depicts an example report on Traffic and Sales by Geography according to one or more embodiments described herein.

FIG. 34 depicts an illustrative computer system for analyzing CRM according to one or more embodiments described herein.

FIG. 35 depicts a mobile system for analyzing CRM according to one or more embodiments described herein.

### DETAILED DESCRIPTION

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present disclosure.

As discussed herein, a system is needed to better track and analyze the CRM of specific businesses. Although car dealerships are referenced throughout the specification, it should be noted that the systems, devices, and methods disclosed herein may be applicable to any merchant concerned about the CRM of their business. Accordingly, it is assumed that one skilled in the art would be able to translate the systems, devices, and methods disclosed herein to any system involving CRM.

In some embodiments, CRM information for one or more merchants (e.g., car dealers) may be compiled into a computer system, like those disclosed herein, in order to determine how much customer traffic they generated each month for each product line (e.g., a car make/model). Although some current technology exists with regard to CRM analysis, such technology falls short of meeting the needs of merchants. For example, existing devices only provide a number or reports and exhibits that report on dealership lead volume by source (e.g., OEM website, 3^{rd} party provider, OEM sponsored dealership websites, etc.) and sales attributed to those leads, which results in close rates.

The shortcomings of these solutions include a lack of identification of all traffic that reaches the dealership. Accordingly, in some embodiments, CRM data is collected from dealers and thus includes all of the traffic that the dealership receives. For example, general systems do not include: all of the traffic sources, vehicle models, salespeople, geography, and the like. Moreover, further embodiments of the system and methods disclosed herein may use a shared sales database that includes dealer information from more than one dealership. Analyzing CRM information in an isolated manner (e.g., on a per dealership level) reduces the usefulness of the analysis. Accordingly, the data in these solutions often contains duplicate records and would require processing and data hygiene operations to be performed before the data can be used in reporting. Current solutions do not provide this functionality.

For the reasons stated herein, embodiments, as discussed herein, provide a CRM traffic defection analysis. In some embodiments, a system may use all of a merchant's (e.g., a dealership's) traffic data pertaining to an new product (e.g., a vehicle) and match it against a shared sales database. This shared sales database may comprise historical CRM data for the dealership being analyzed, as well as other dealerships that may be in relative proximity to the dealership or may be commonly owned. In addition, the CRM data may be collected and recorded in real-time (i.e., while a purchase is being made at a competing business).

As discussed herein, the CRM data may be collected using various methods and may be collected over multiple mediums (e.g., website data, retail data, brick and mortar foot traffic data, etc.). In one non-limiting example embodiment, the data collection may be manual, such as, for example, a receptionist or sales person may collect and enter consumer-related information into the system so that it can be tracked. Additionally or alternatively, an embodiment may automatically collect the consumer data. In such an embodiment, data collection may take place through the use of various sensors (e.g., barcode scanners, computer vision, facial recognition, etc.). It should be understood that various methods of automated data collection can be used, such as, for example, the type of data collection that is used in Amazon Go stores. AMAZON GO is a registered trademark of Amazon Technologies, Inc. in the United States and other countries.

In some embodiments, customer data may include, for example, a geographic location, a bounce rate, a traffic source, an associated sales person, a target product, and demographic data (e.g., name, address, age, phone number, income, purchase history, financial status/history, etc.) of the customer. As should be understood by one of ordinary skill in the art, traffic source data is used to determine which traffic sources (e.g., search engines, advertising sources, referral sources, etc.) one or more consumers used to arrive at the merchant's website or retail location. As should be further understood by one of ordinary skill in the art, a bounce rate generally refers to a percentage of consumers that leave a website or retail space without engaging with any additional resources (e.g., other merchant webpages, merchant-associated social media, virtual or physical salespeople, etc.).Generally, a high bounce rate indicates that the consumers visiting a retail location or website are not interested in what is being offered or that the barrier to entry is too high.

In some embodiments, as discussed herein, an output may provide a dealer with insights into where customers originated and/or whether they bought any product. Specifically, those customers that have contacted the dealership and actually purchased a vehicle (e.g., at the dealership being analyzed or otherwise) are recorded. In further embodiments, the system may also record how many days passed from the initial contact with the merchant until a purchase was made, or how many visits a specific consumer made to one or more dealerships prior to making a purchase. In a further embodiment, the system may provide a defection analysis by traffic source, requested vehicle model, salesperson, geography, etc. Traffic sources may be divided by store locations, referrals, advertising source, search engine, or hot linking.

Thus, in some embodiments, the system may help a dealer or merchant identify operational and/or process deficiencies in their company. This is because the system can provide detail on why they are losing customers who at one point inquired about buying a product (e.g., vehicle) from the merchant.

In further embodiments, the system may inform the merchant where they have performance improvement opportunities. For example, the system may provide guidance related to: overall follow-up process using days-to-sale analysis, traffic mix by understanding which sources are providing the best results (e.g., sales vs defections), individual model lines by better understanding which vehicles have the most defections and which dealerships customers are purchasing from, individual salespeople by providing management an assessment of each person, a market by identifying where traffic is coming from and where the dealer is selling/losing by zip code, or the like. All of these processes may enable the dealer to better target their marketing activity in the most efficient manner.

The present disclosure provides systems, methods, and/or computer program products. The computer program product may include a computer readable storage medium (or media) having computer readable program instructions thereon for causing a processor to carry out aspects of the present disclosure.

The computer readable storage medium can be a non-transitory tangible device that can retain and store instructions for use by an instruction execution device (e.g., one or more processors). The computer readable storage medium may be, for example, but is not limited to, an electronic, magnetic, optical, electromagnetic, or semiconductor storage device, or any suitable combination of the foregoing. A non-exhaustive list of more specific examples of the computer readable storage medium includes the following: a portable computer diskette, a hard disk, random access memory (RAM), read-only memory (ROM), erasable programmable read-only memory (EPROM or Flash memory), static random access memory (SRAM), a compact disc read-only memory (CD-ROM), a digital versatile disk (DVD), a memory stick, a floppy disk, a mechanically encoded device such as punch-card(s) or raised structures in a groove having instructions recorded thereon, and/or any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium, or to an external computer, or external storage device via a network, for example, the Internet, a local area network (LAN), a wide area network (WAN) and/or a wireless network. The network may comprise conductive transmission cables (e.g., copper cables), optical transmission fibers, wireless transmission, routers, firewalls, switches, gateway computers, and/or edge servers. A network adapter card or network interface in each computing/processing device receives computer readable program instructions from the network and forwards the computer readable program instructions, for storage in a computer readable storage medium, within the respective computing/processing device.

Accordingly, in some embodiments, a user may determine what, if any, reports to display within the system. Based on this determination, an embodiment may automatically generate a customized user interface via a website or web interface referred to herein as a customized user portal. The customized user portal is stored on a storage device connected to a network. A uniform resource locator (URL) may be generated that points to the customized user portal. The URL may be sent via electronic mail (e-mail), hosted as a stand-alone website, incorporated into an existing website or the like to provide a user with an easily accessible tool.

Thus, after the creation of the customized user portal, an embodiment may push a user (e.g., salesperson, manager, etc.) a definable collection of report links to a user portal in order to enable users to simply and easily select one or more reports that they wish to review. In order to achieve this goal, an embodiment may be required to request user authentication and access level to view the reports.

The illustrated example embodiments will be best understood by reference to the figures. The following description is intended only by way of example and simply provides certain illustrative embodiments.

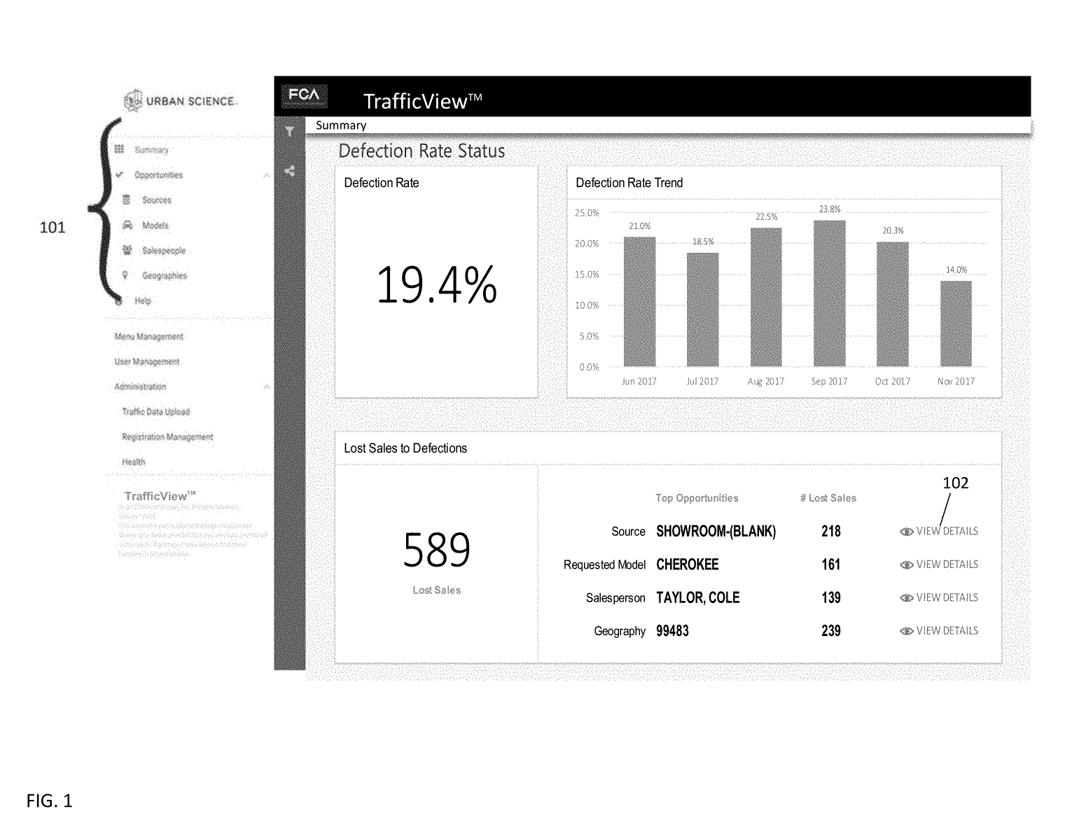

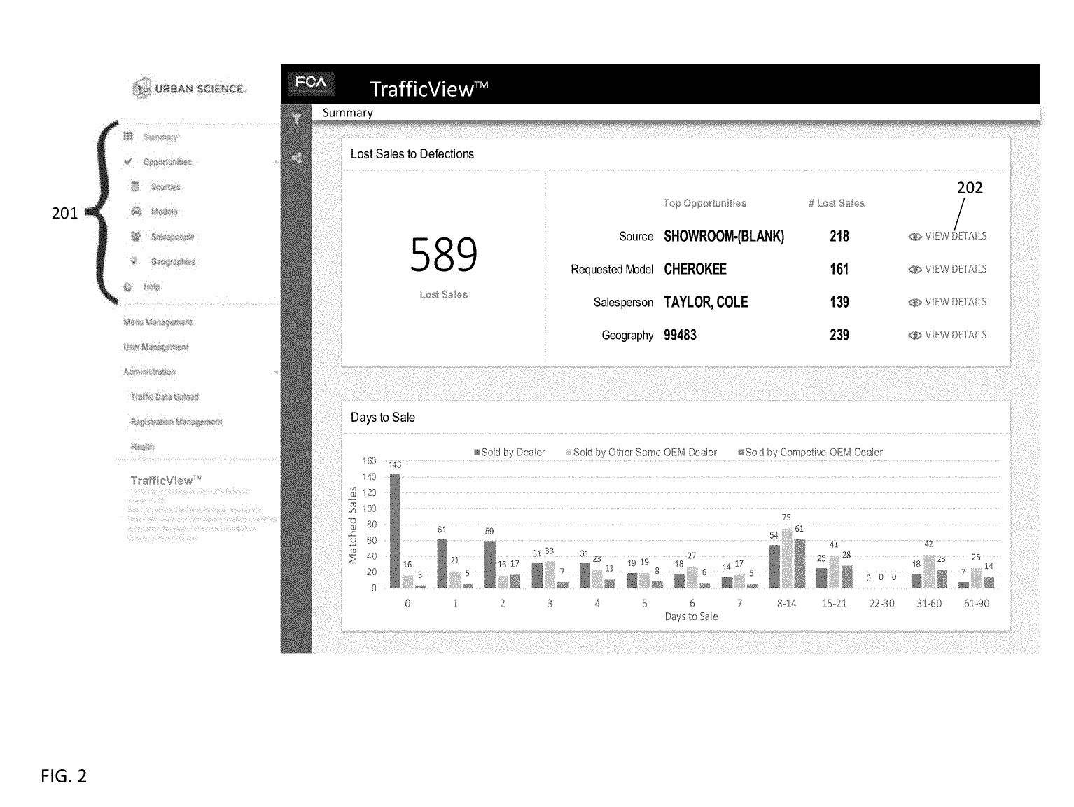

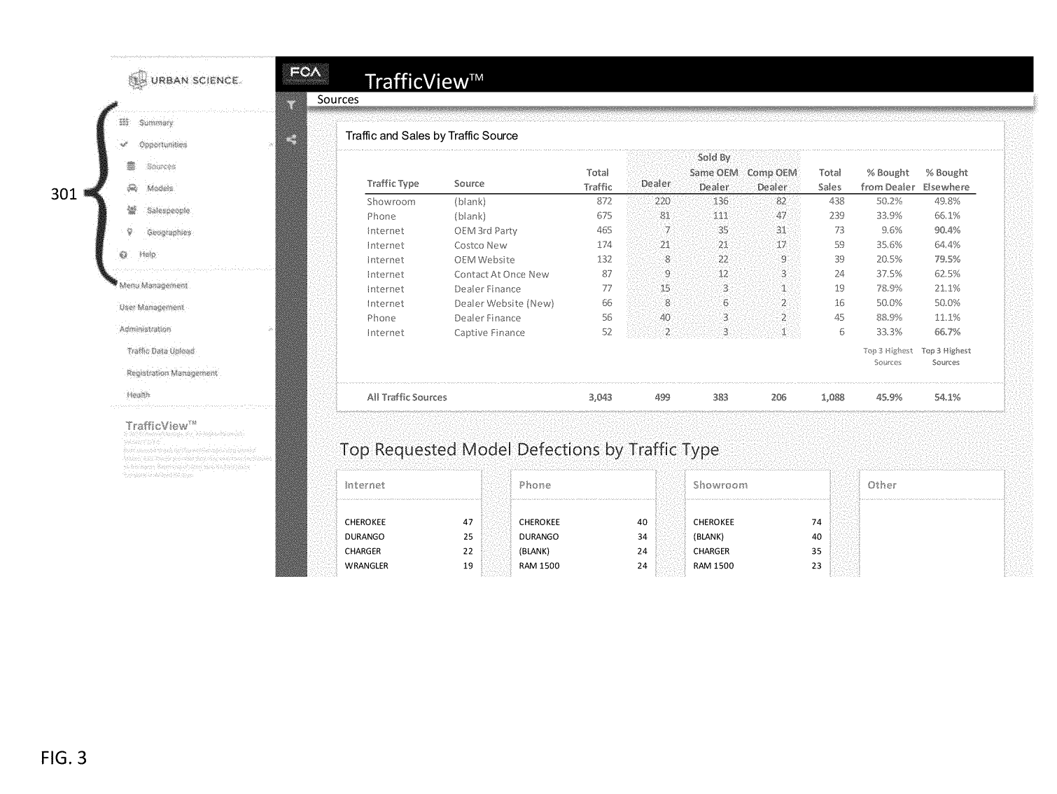

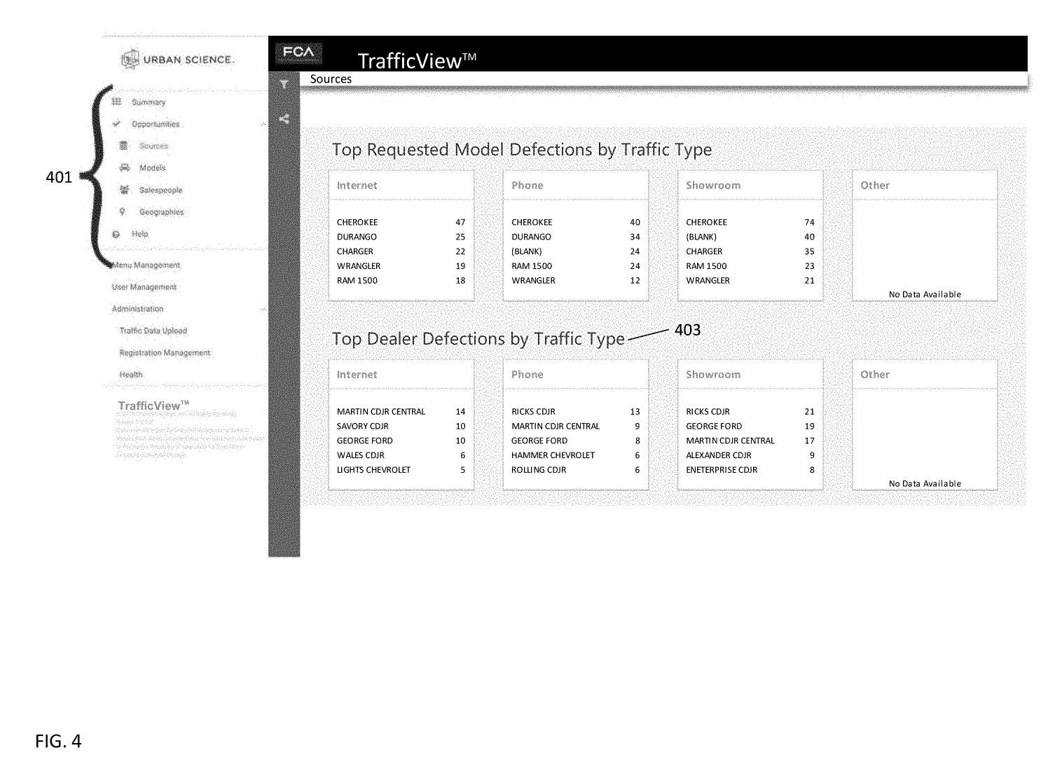

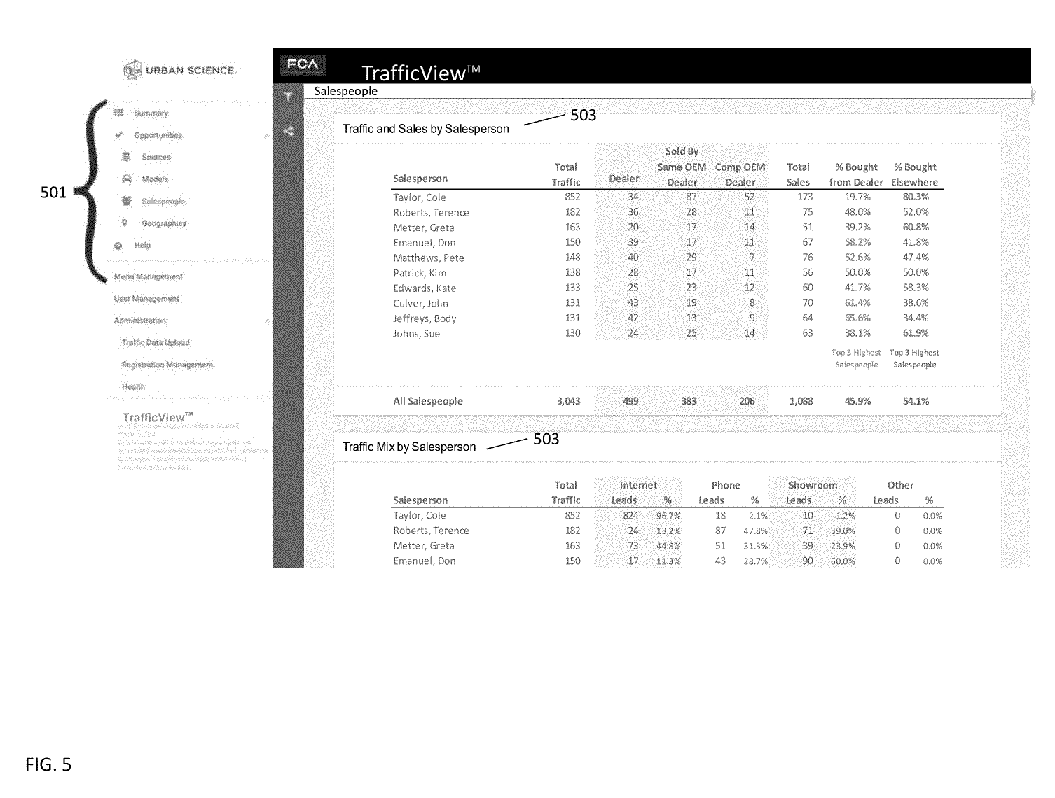

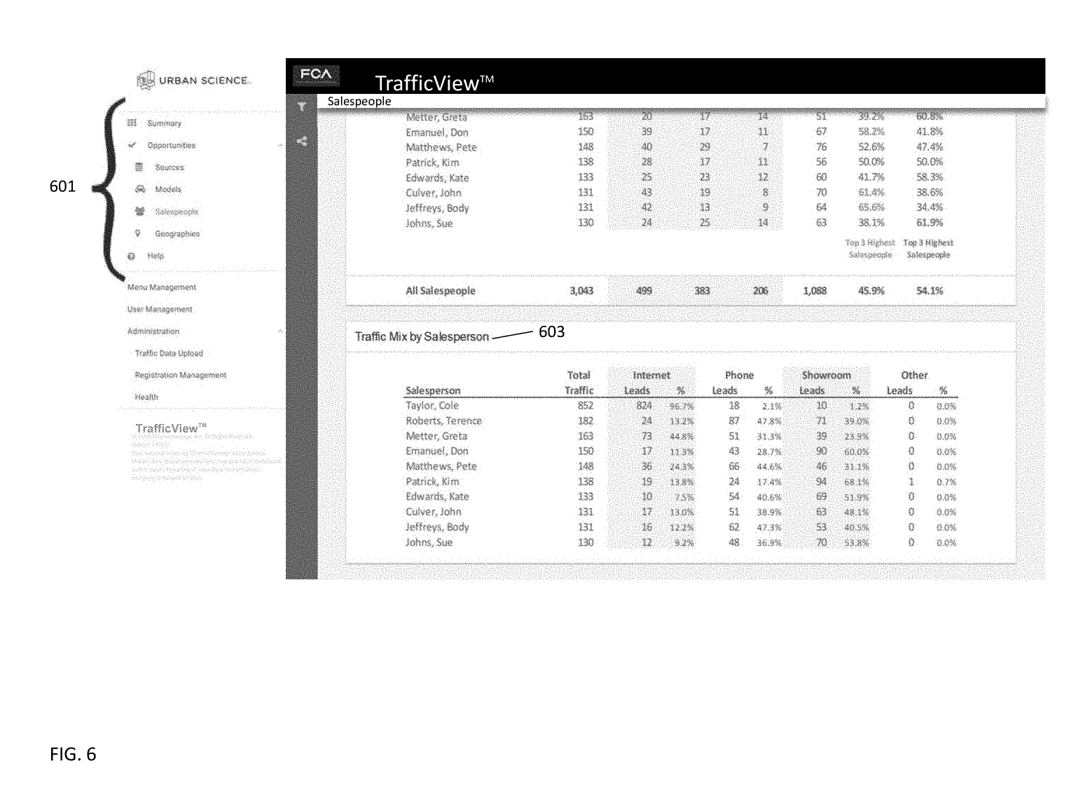

As discussed herein, some embodiments may be web-based in nature. For example, referring to FIGS. 1-6, illustrative screen captures are shown of a website that presents information to a user. In some embodiments, the User Interface (UI) may be built using a material design language (e.g., Google's Material Design Language), which is a visual language that synthesizes the classic principles of good design with the innovation and possibility of technology and science. This allows the system to develop a single underlying system that can create a unified experience across various platforms and devices (e.g., devices with varying screen sizes such as mobile devices). As the world becomes more mobile, mobile precepts are fundamental, and touch, voice, mouse, and keyboard are all vital input methods. Accordingly, and as shown in FIGS. 1-6, some embodiments may generate a web interface to allow a user to view and interact with their analysis.

Thus, the embodiments described herein present a technological improvement over the art that is necessarily rooted in computer technology (e.g., automatically building a customized web-based solution to analyze valuable CRM data) and amounts to a significant improvement over conventional systems, which are discussed herein. For example, an embodiment may be able to utilize lightweight responsive web technologies such as: Angular, Typescript, HTML 5, CSS 3, industry leading backend technologies such as, Microsoft ASP.Net, Web API's, C sharp, .Net Core, APIGEE, and Mongo DB (No SQL Database), developed middle tier Integration Data Source (IDS) module to support, single instance, multi-tenant, and quick configuration change to switch between Test and Marketing Intelligence Cloud (MIC) data sources. Each of these features may allow an embodiment to de-couple its dependency while further developing new or alternative UI's without require backend (MIC) modification. Furthermore, in some embodiments, the system may allow for easy onboarding for new clients using Tenant GUID, and/or use internal C4 MIC platform as backend to provide data, and/or Consumer Sales Matching API's and Campaign API's.

In one or more additional embodiments, the system may log into one or more applications either through a single authentication process via an OEM's dealer portal or through credentials provided by a third party (e.g., Urban Science, AutoHook, etc.). Once a user logs in, they are able to select from a list of pages to see various exhibits (charts/tables) and identify where there are opportunities for improvement (e.g., 101, 201, 301, 401, 501, and 601). In further embodiments, some of the webpages may have page specific filters that allow the user to select detail on a specific traffic source, new vehicle model, salesperson, or geography (e.g., 102 and 202). Various levels of authentication may also exist such that differing levels of access may be given to individuals based on their needs. For example, in some embodiments, OEM users may be able to select and see multiple dealerships 403, while individual merchants (e.g., dealers) may only be able to see their own statistics 503.

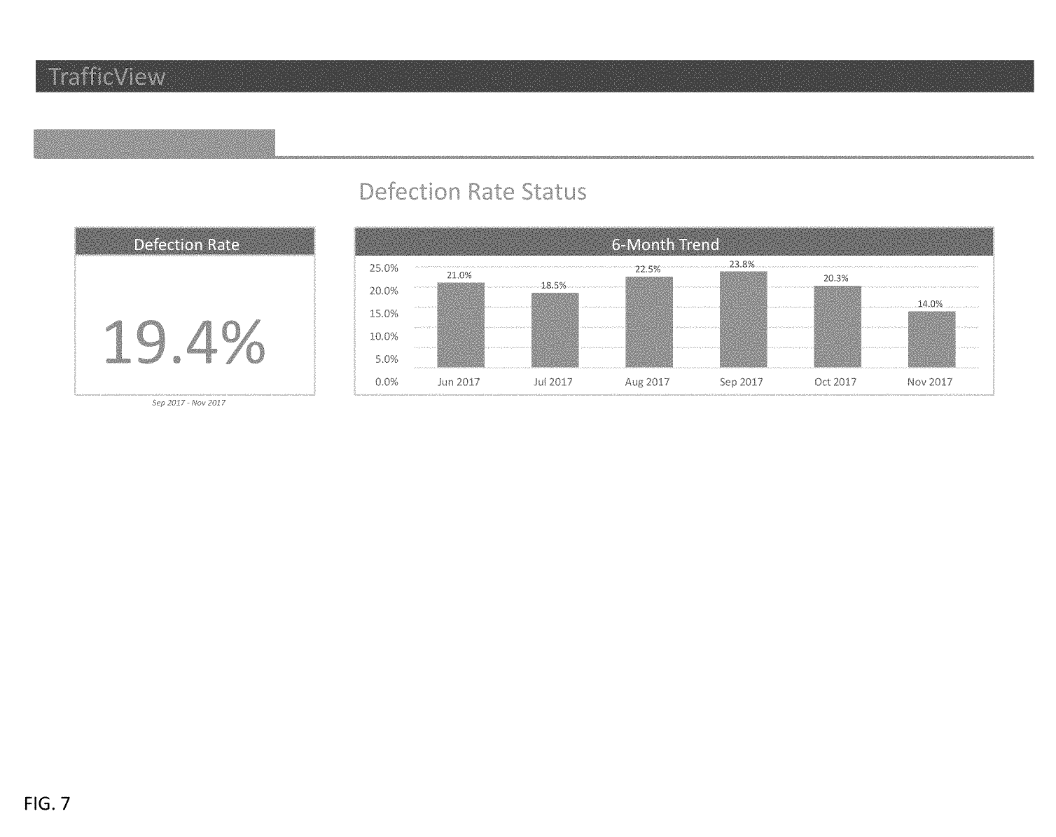

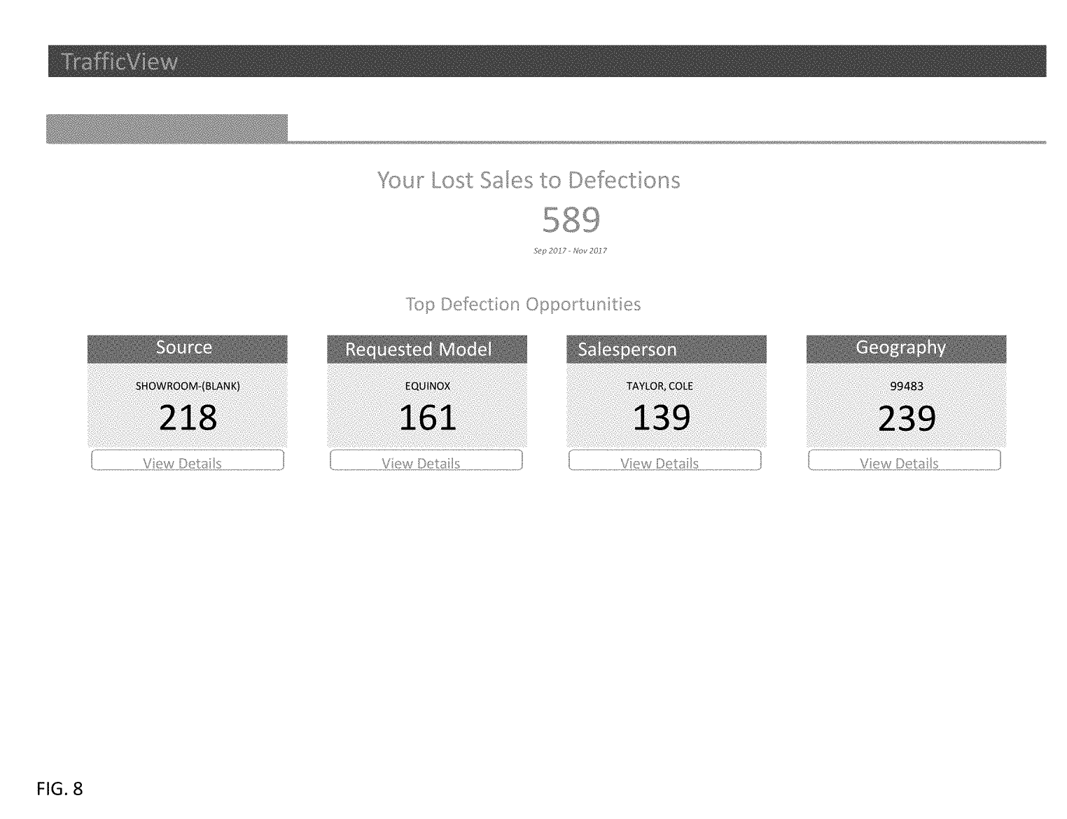

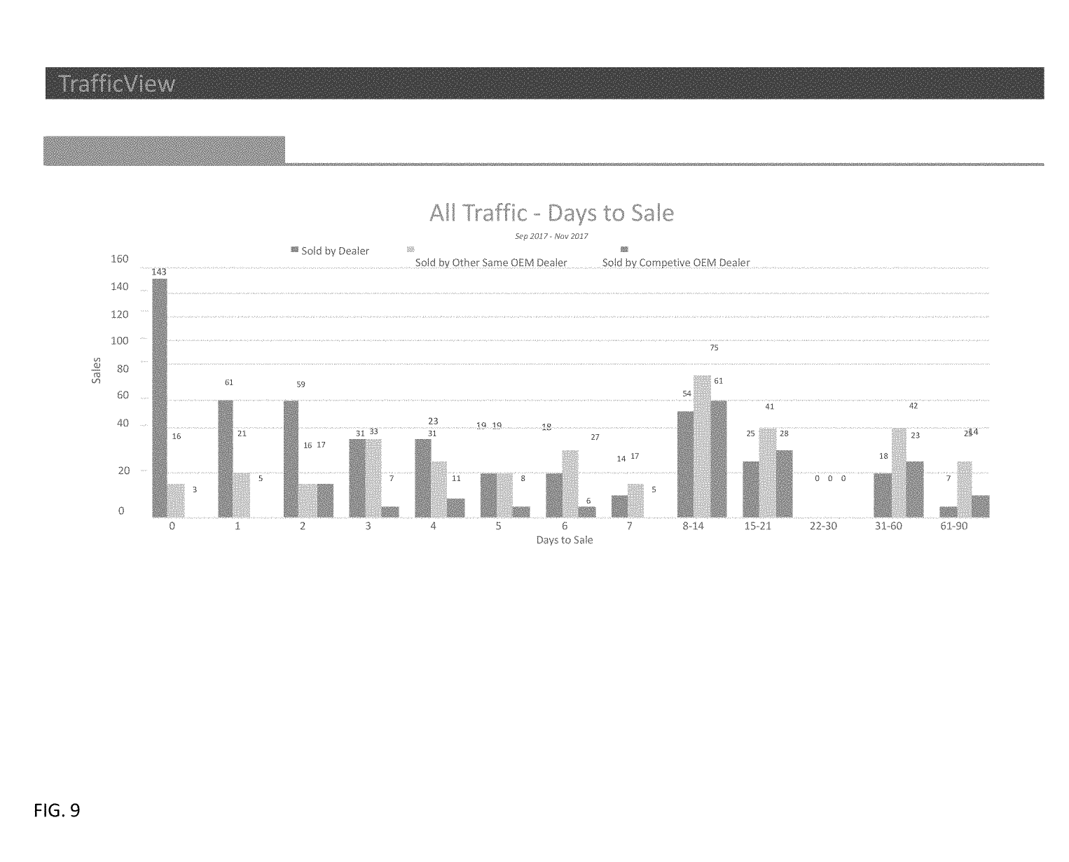

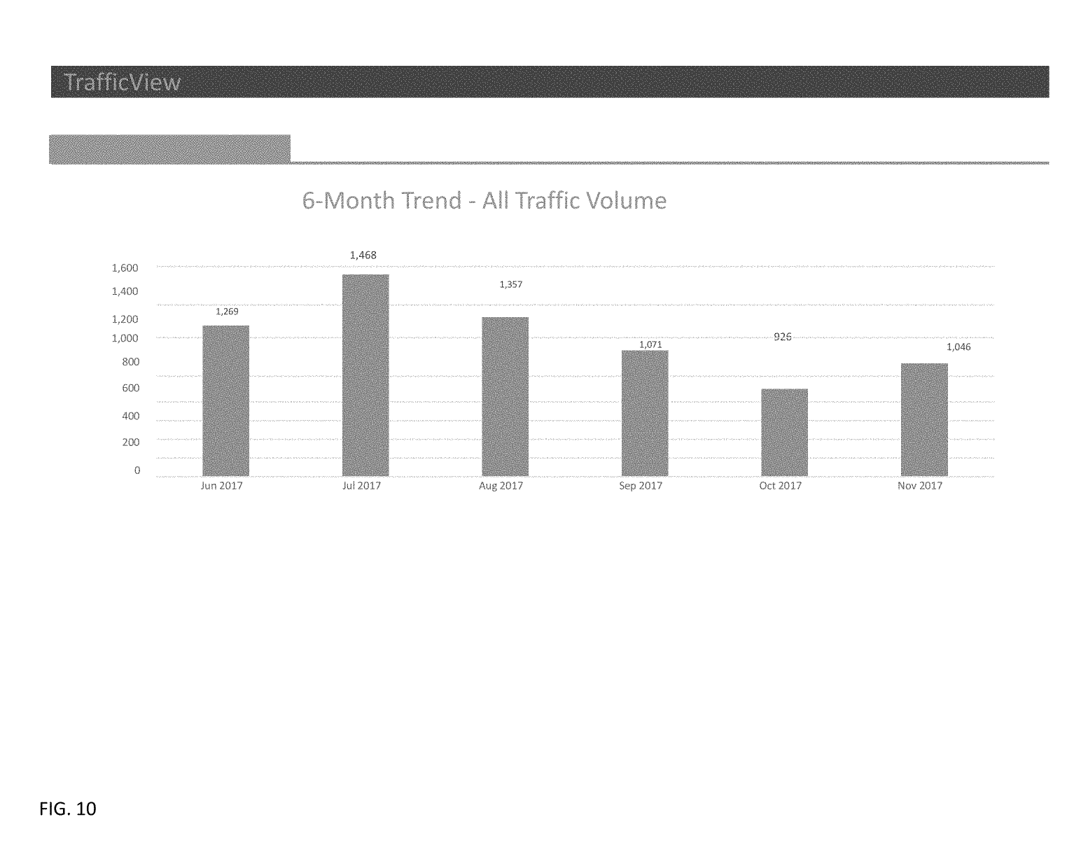

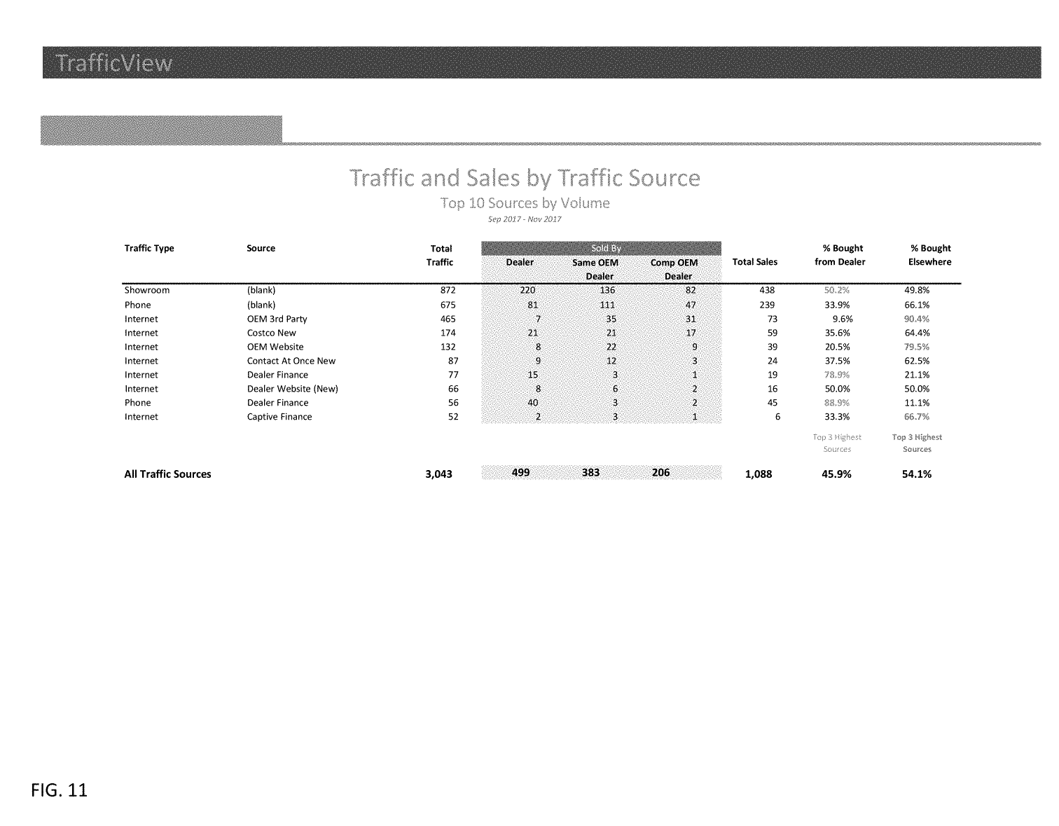

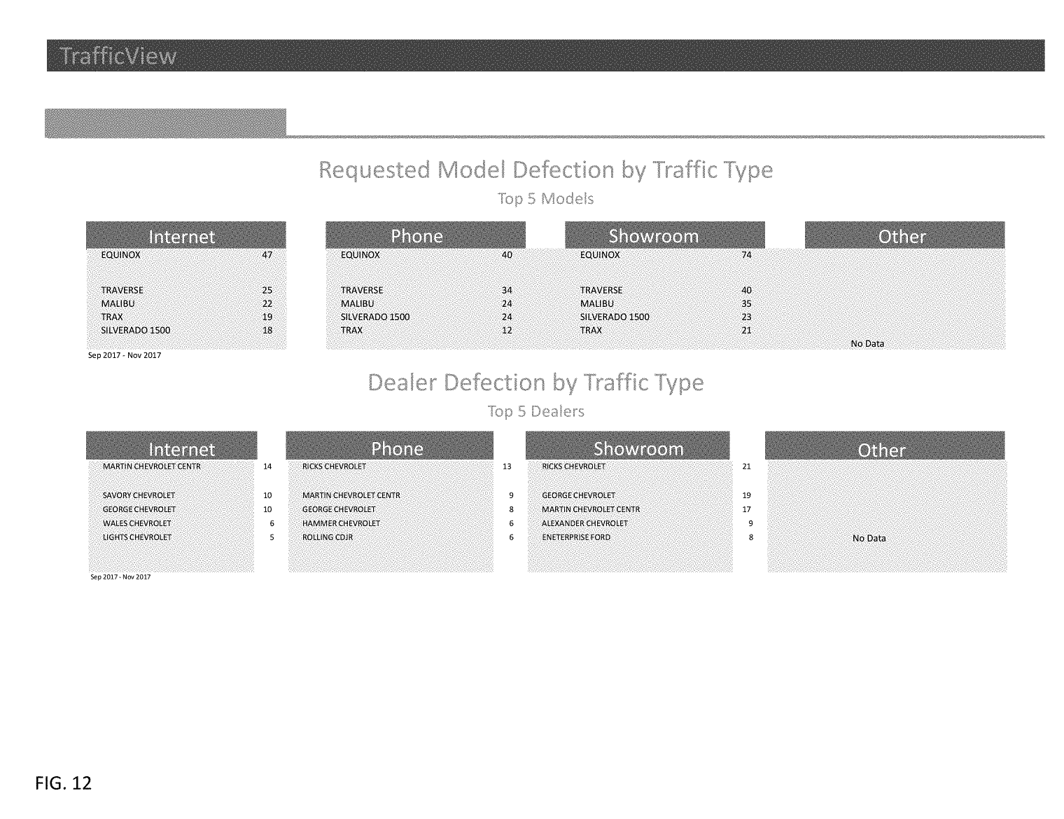

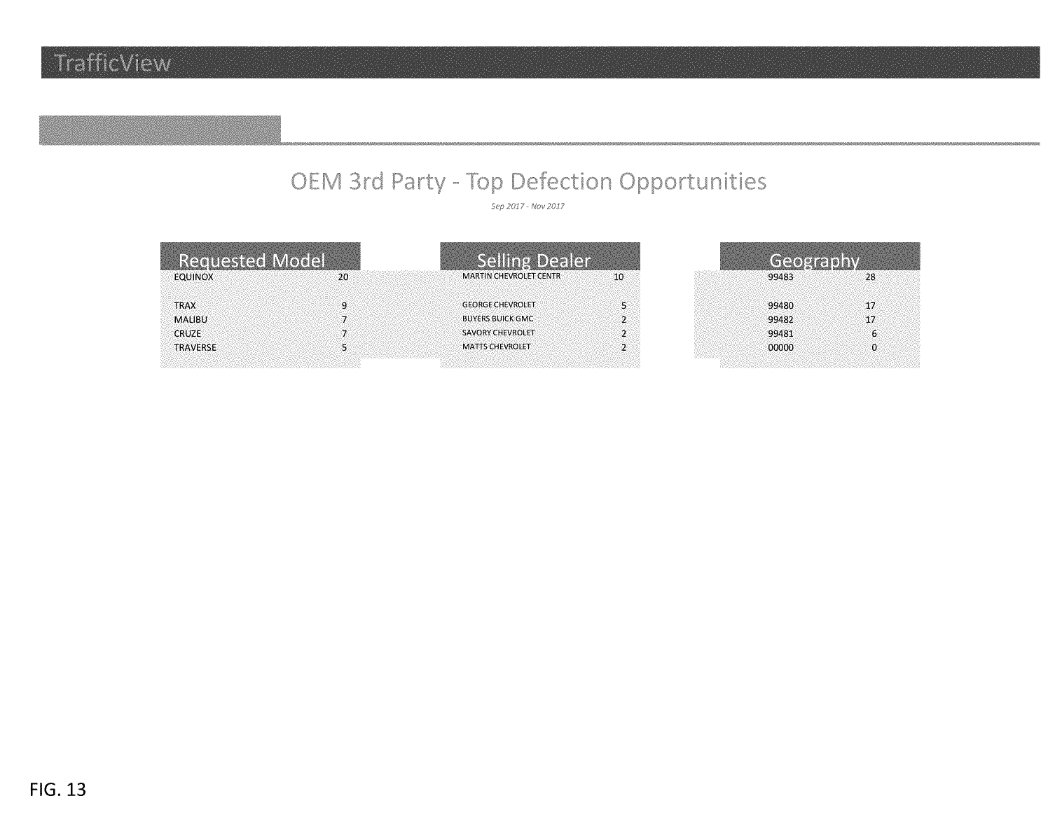

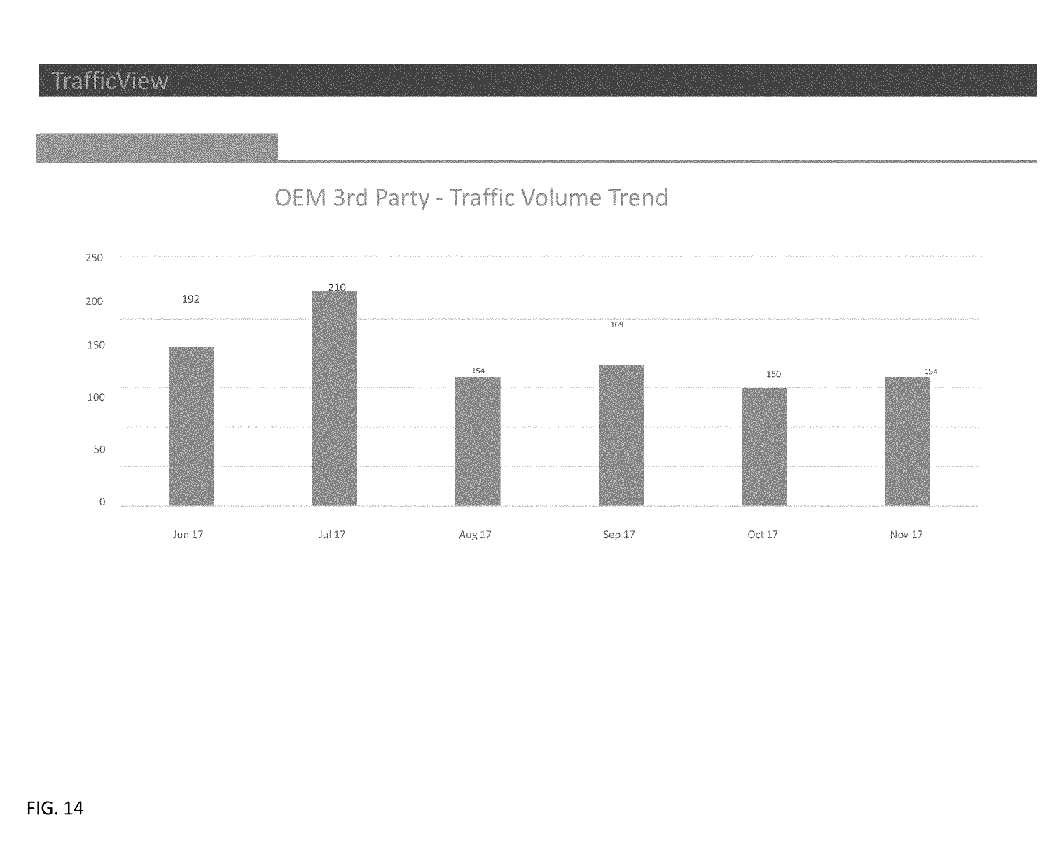

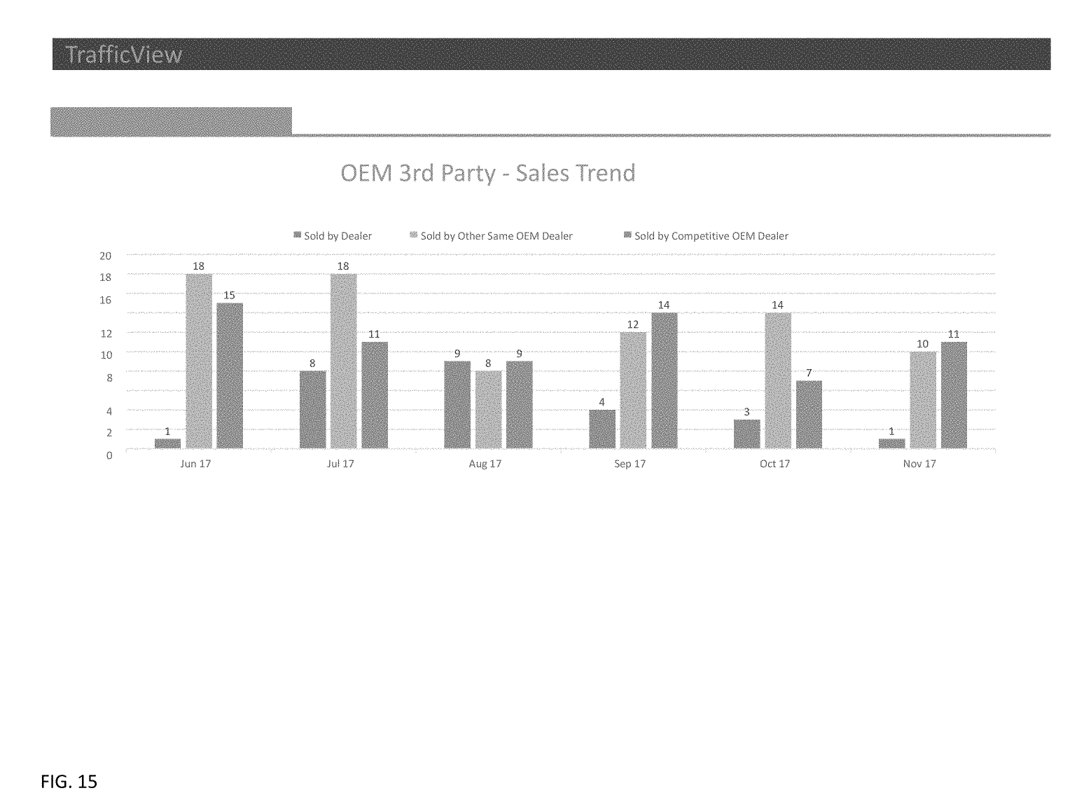

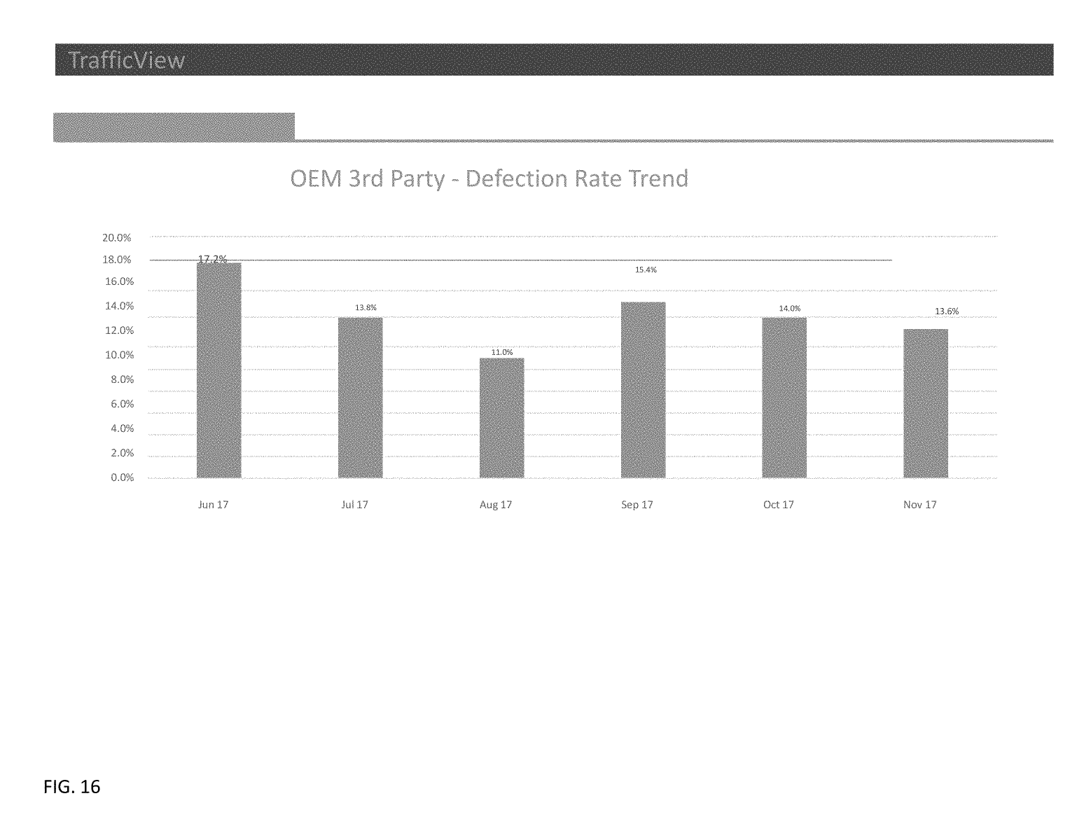

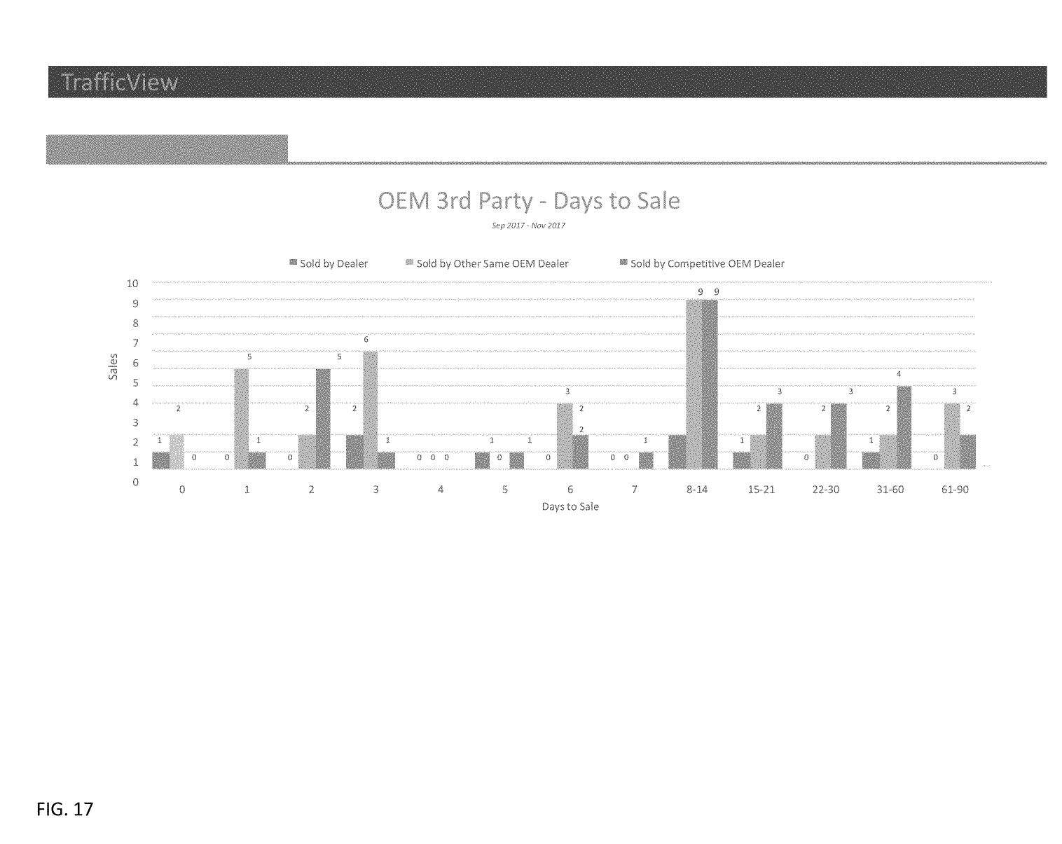

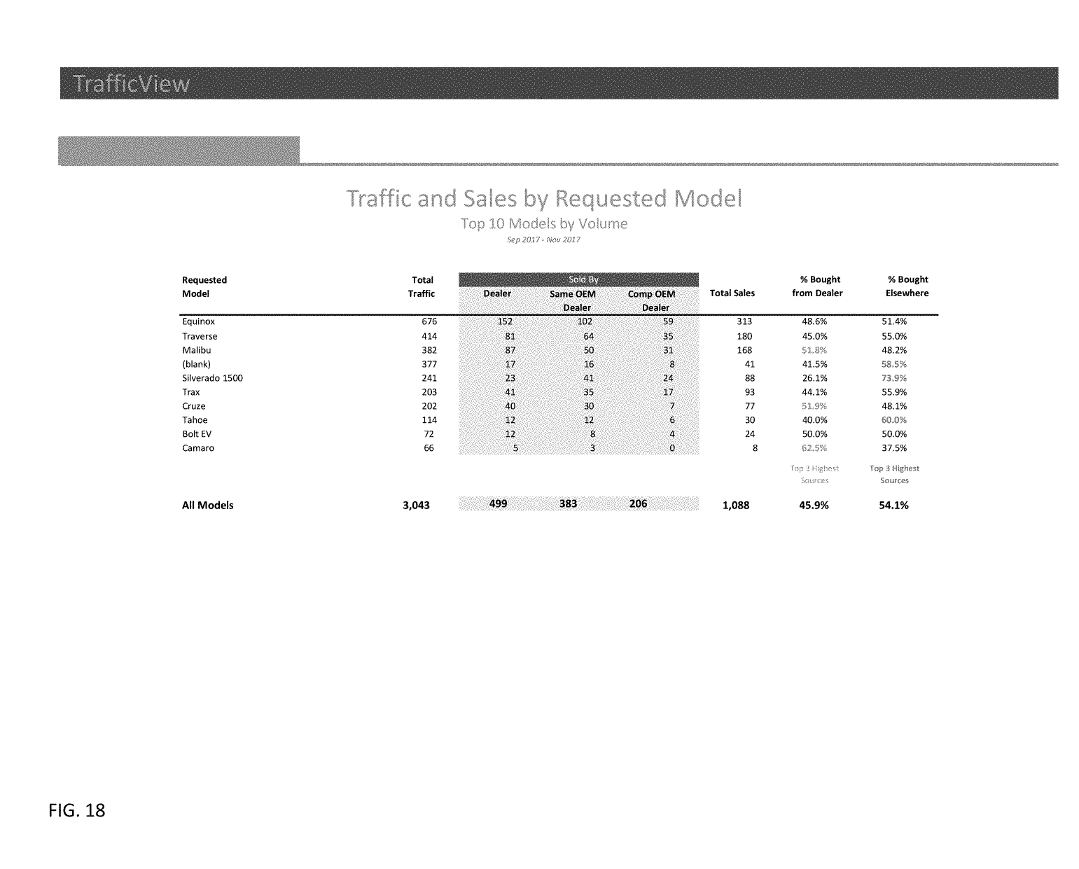

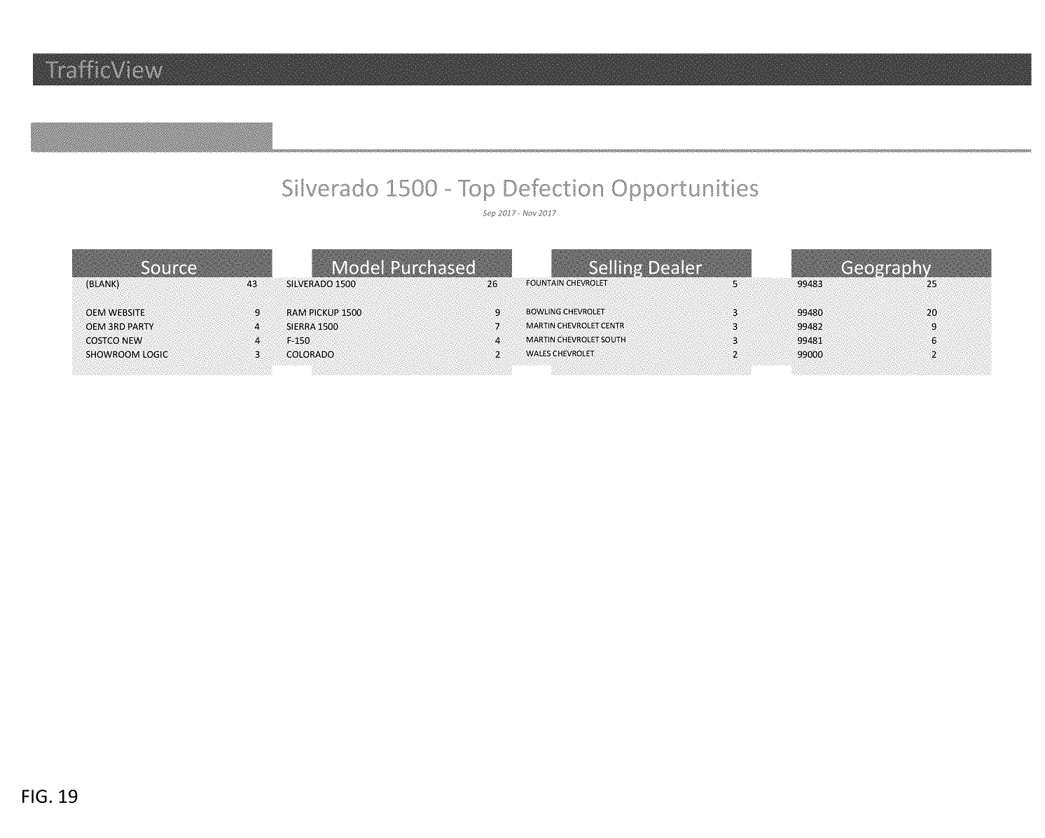

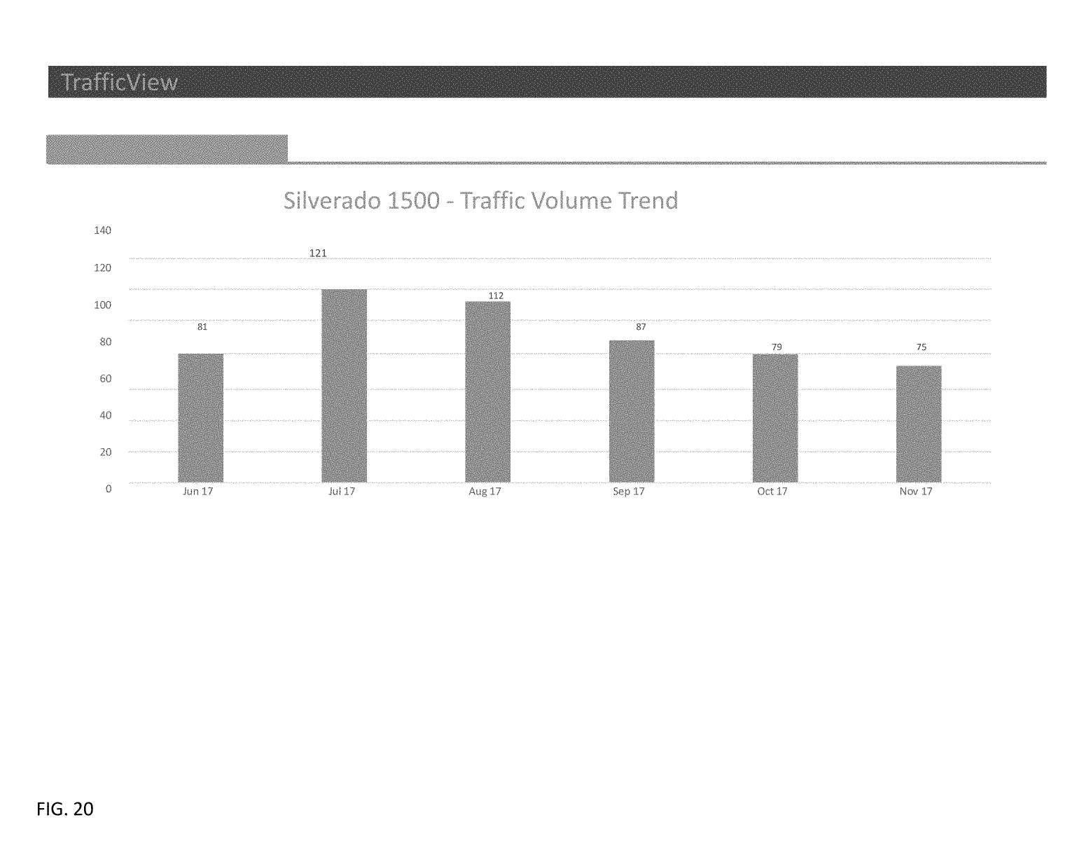

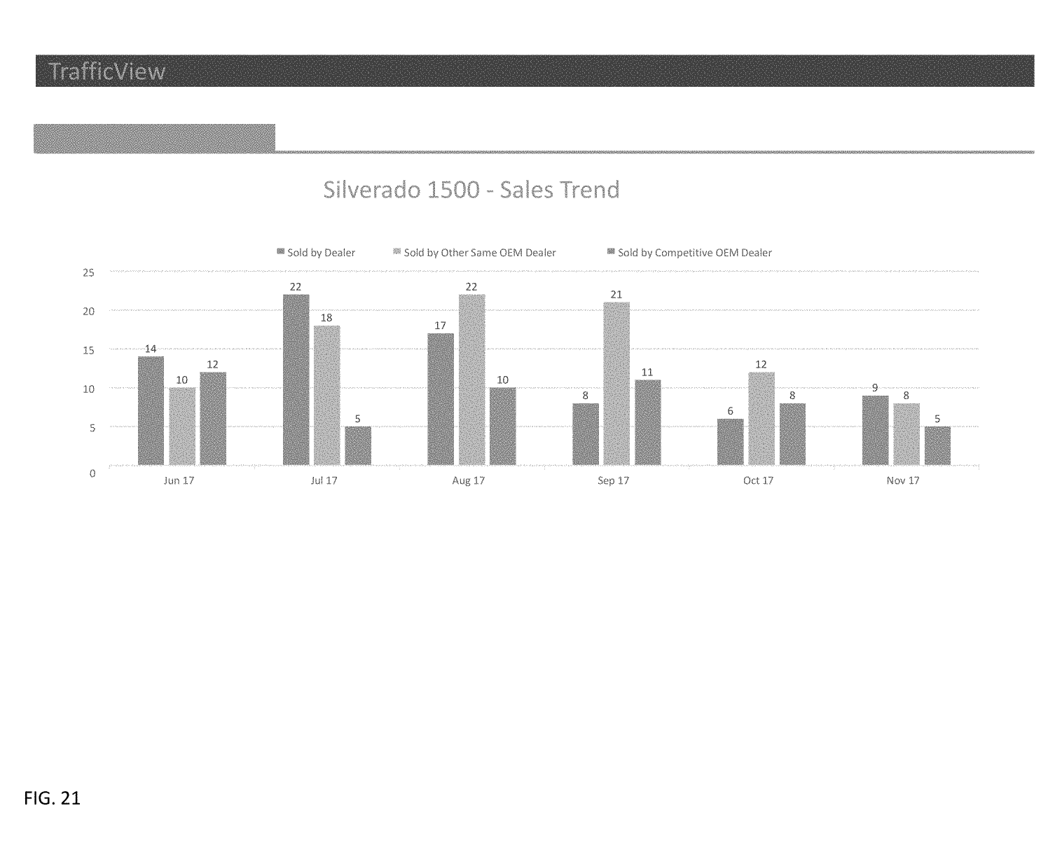

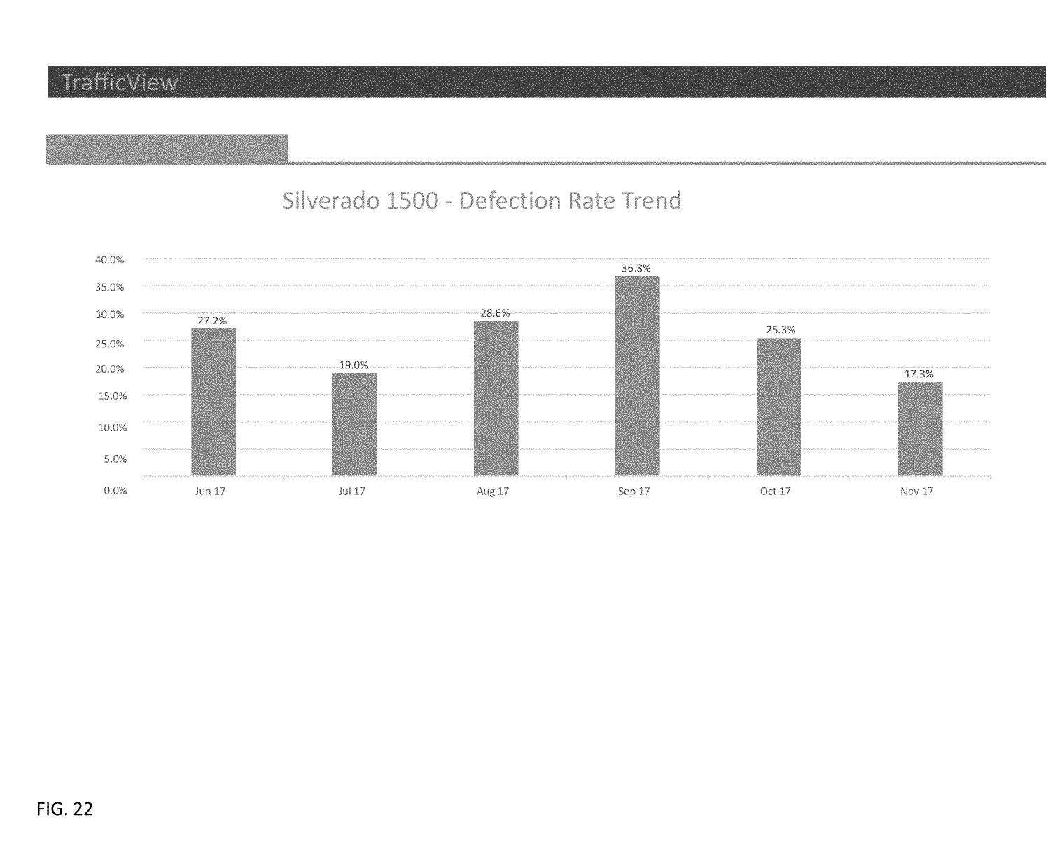

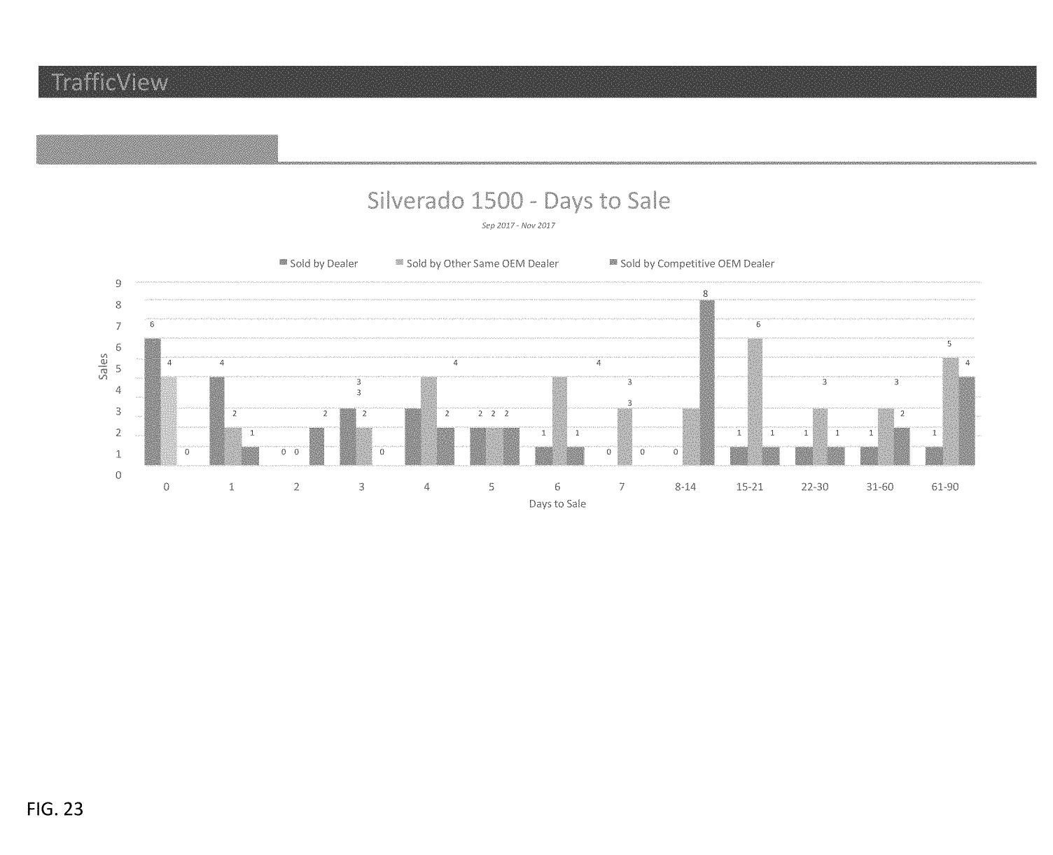

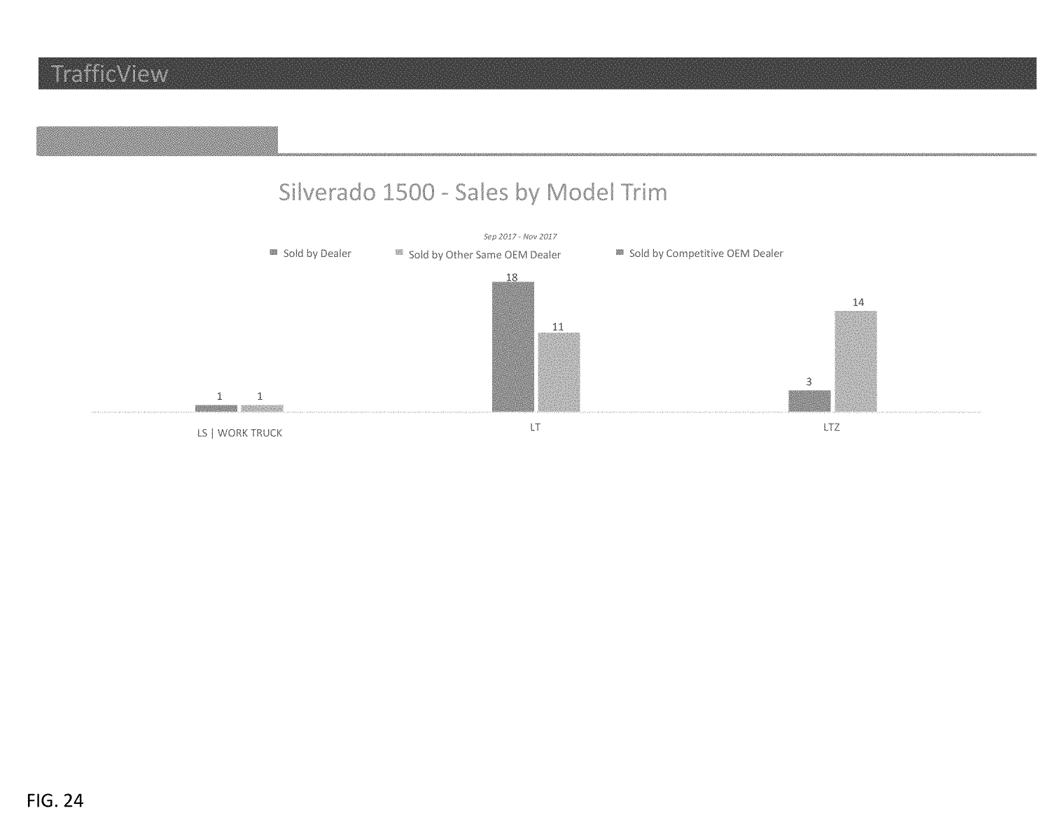

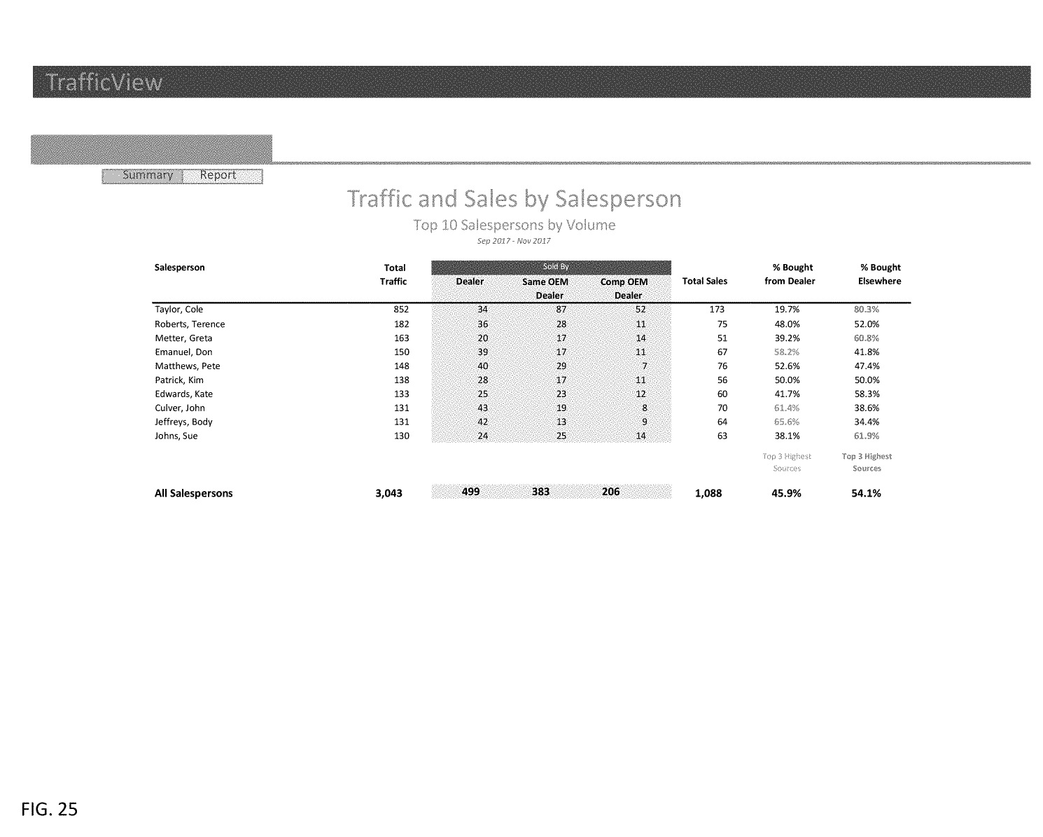

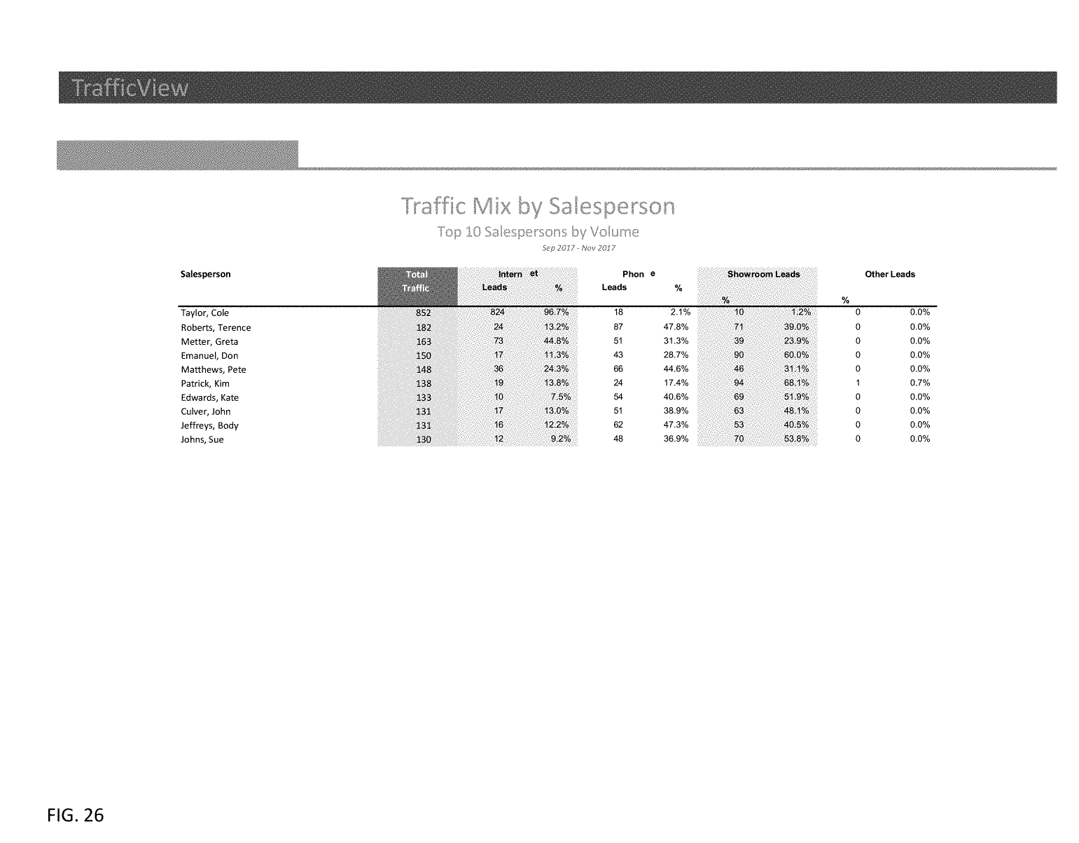

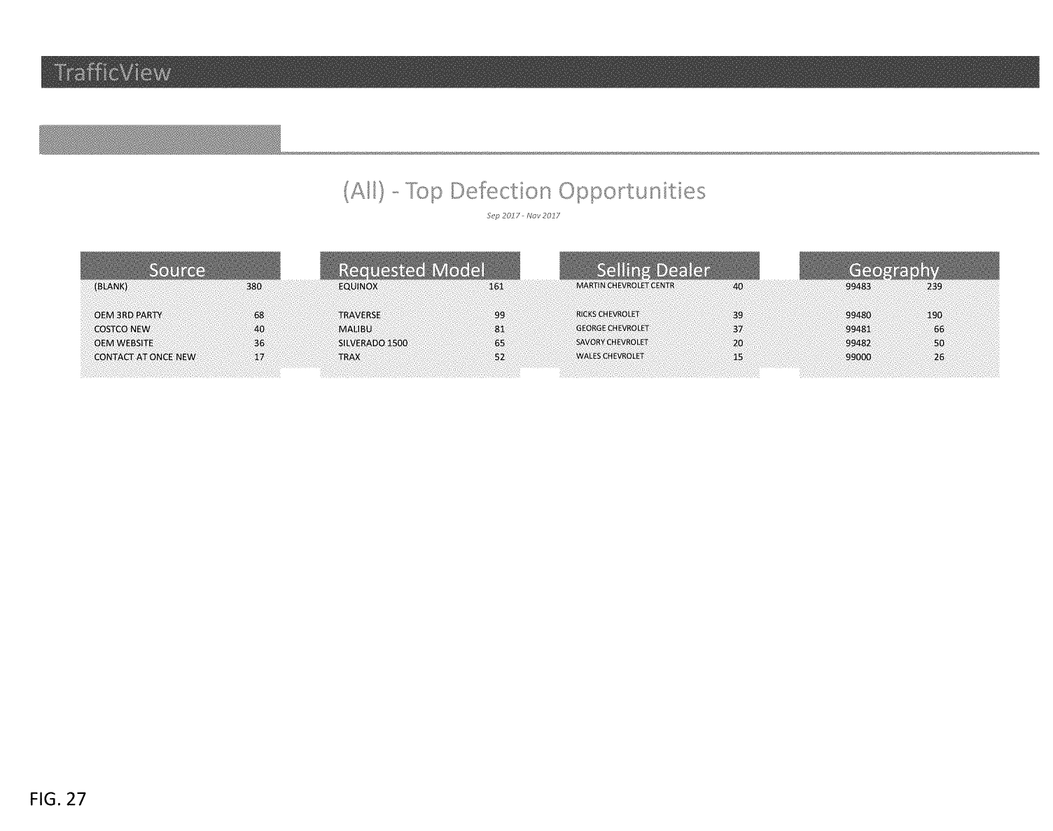

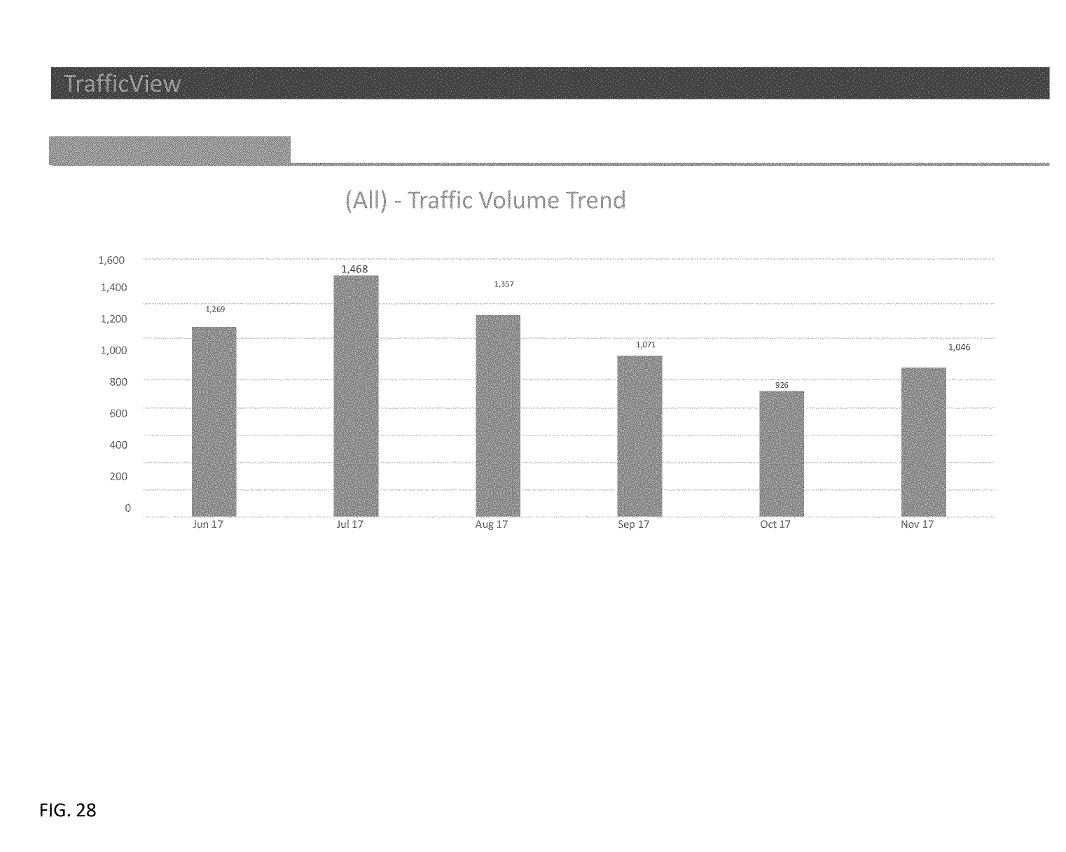

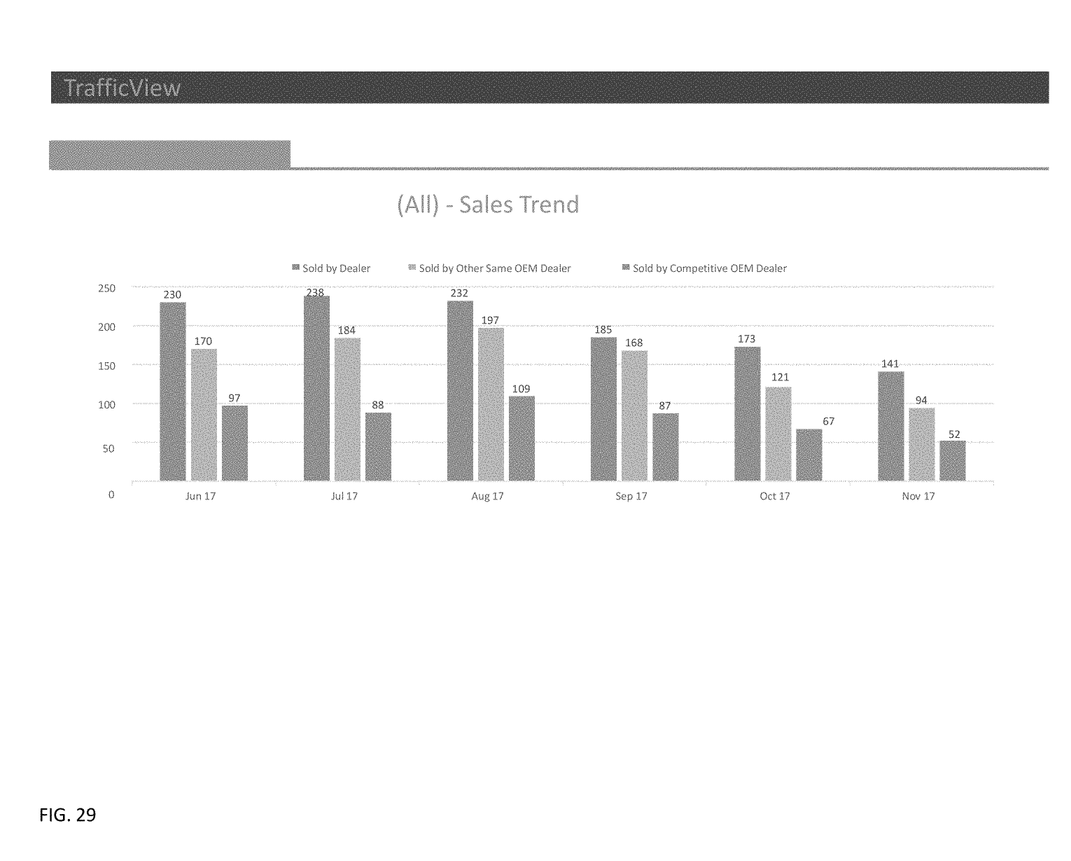

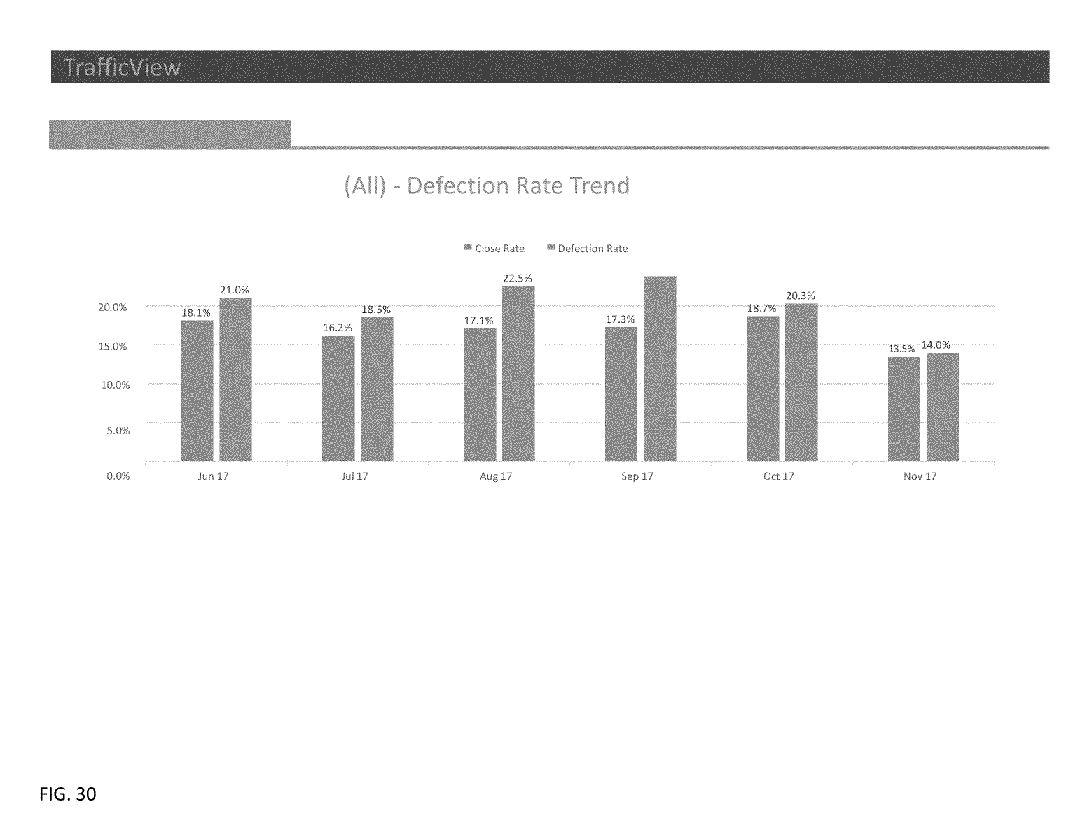

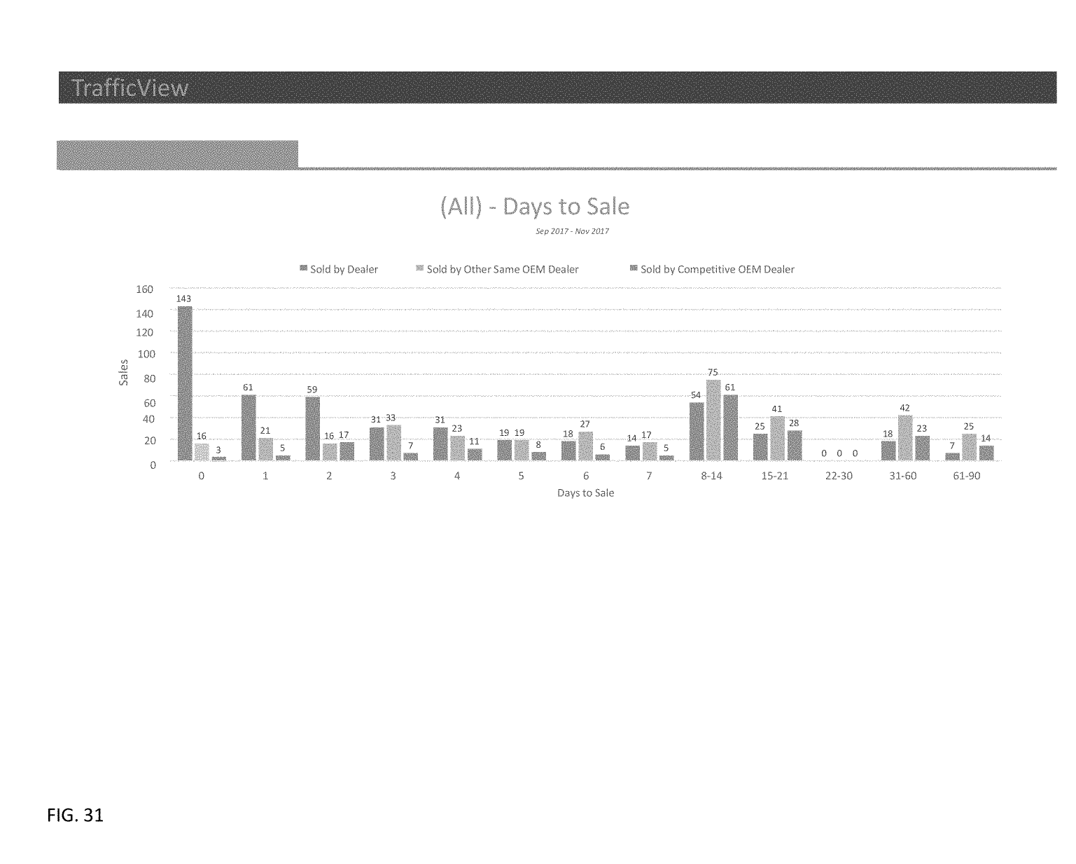

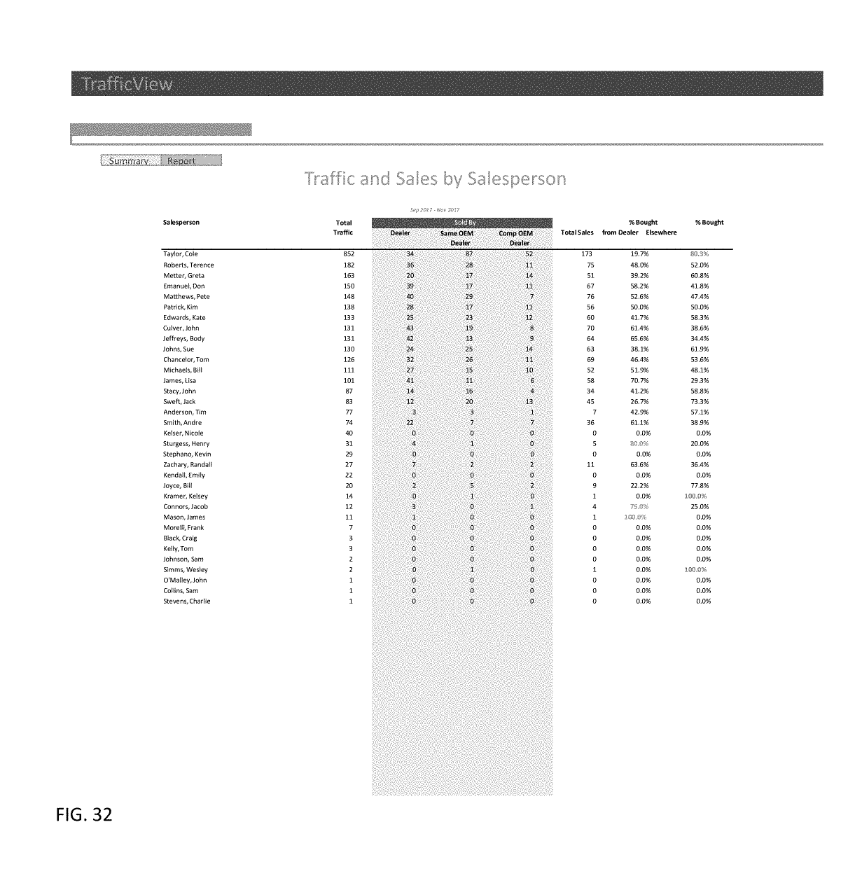

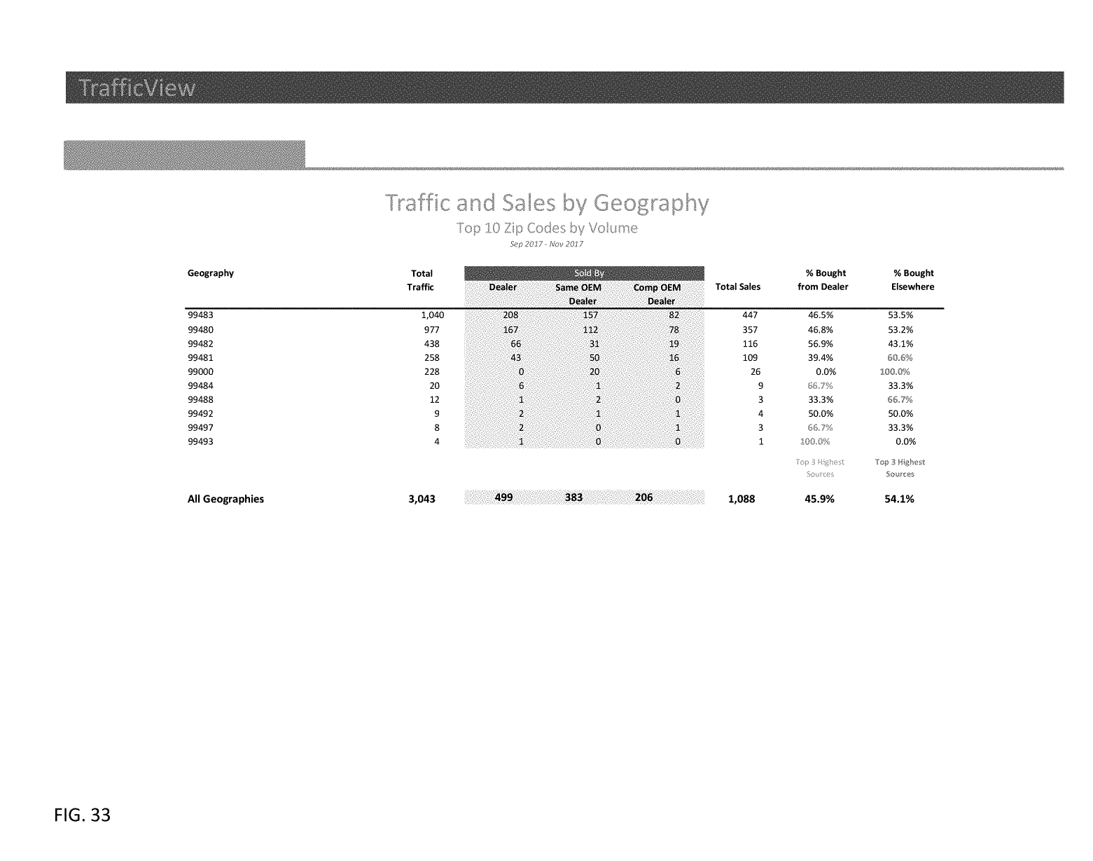

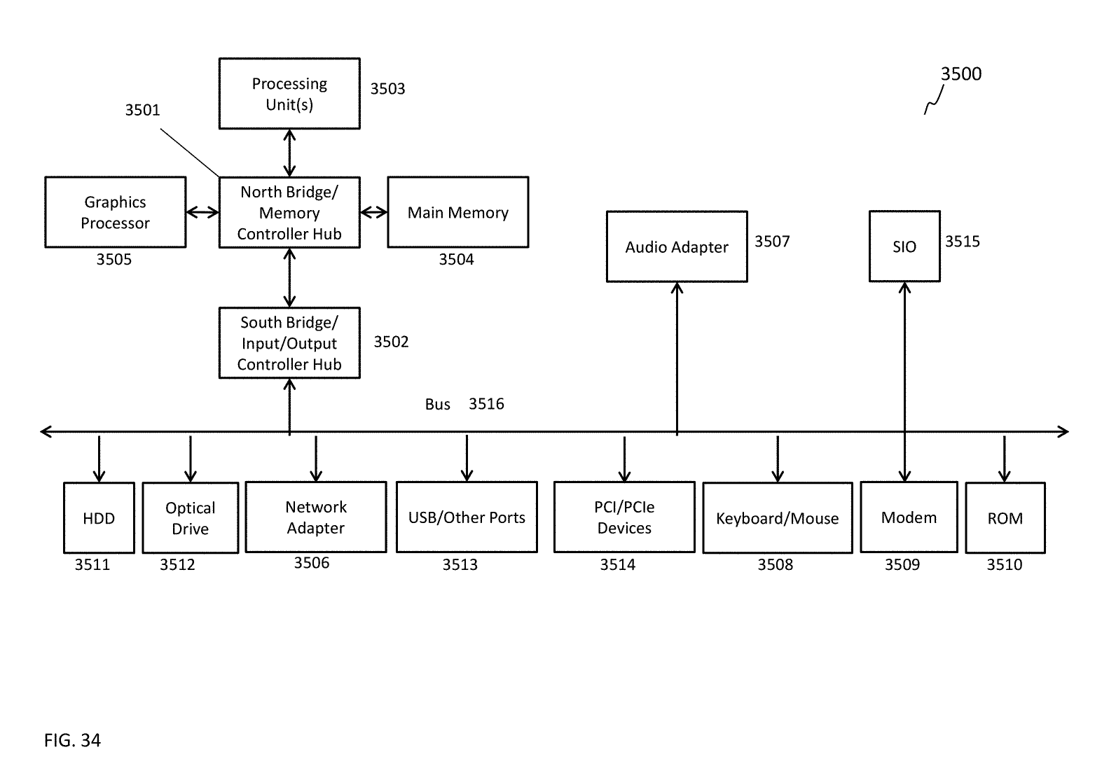

As discussed herein, some embodiments will be web-based in nature, but it should be understood, that the illustrative examples discussed herein may be used in a stand-alone application. In some embodiments, the application may be a local application (i.e., a single dealership or merchant tracking their CRM); however, alternative embodiments may also be utilized in which the application accesses a database on a remote device that is accessible by multiple instances of the application (i.e., an OEM database shared with its multiple dealerships). In further embodiments, the web-based version may have full API integration with each CRM vendor utilized by an OEM's dealership network, or, alternatively, full API integration with an OEM that integrates with each CRM vendor. Thus, the embodiments disclosed herein may be scalable (e.g., for small CRM vendors that are only used by a few dealerships, embodiments may allow for a manual upload capability, which would allow for a single dealership to load its CRM data). Accordingly, various additional illustrative examples of one or more embodiments are shown in FIGS. 7-34.

Computer readable program instructions for carrying out operations described herein may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on a user's computer, partly on the user's computer, as a stand-alone software package, partly on the user's computer and partly on a remote computer, or entirely on the remote computer or server. In the last scenario, the remote computer may be connected to the user's computer through any type of network, including a LAN or a WAN, or the connection may be made to an external computer (for example, through the Internet using an Internet Service Provider).

The methods, systems, and computer program products are described herein with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer-implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

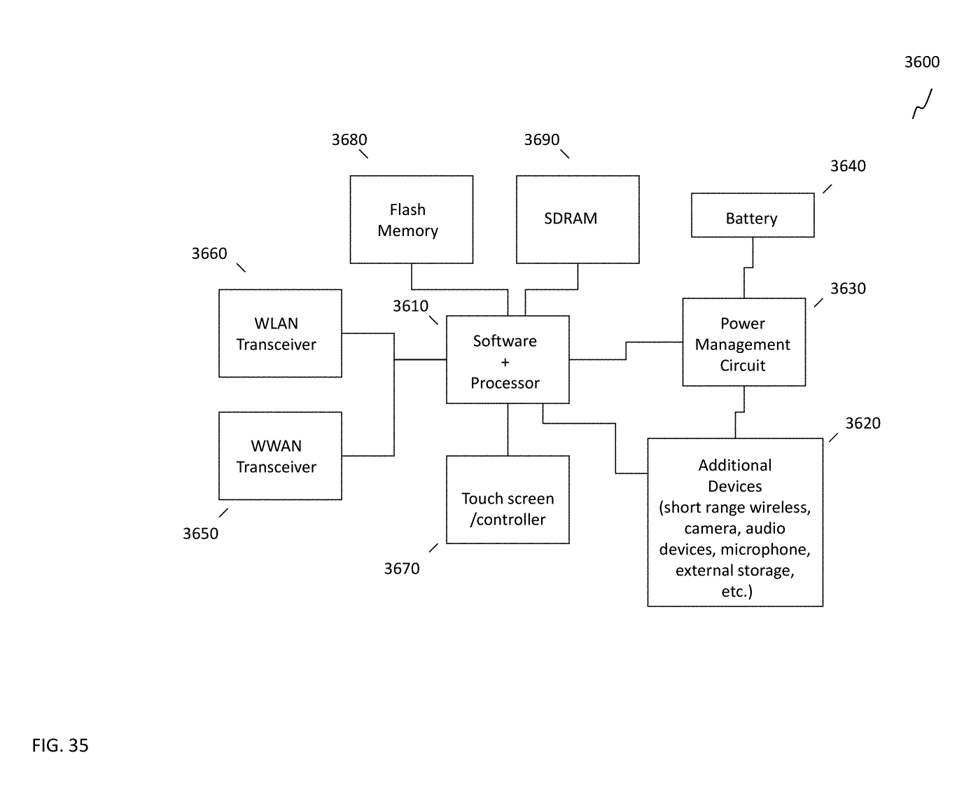

FIG. 35 is a block diagram of an illustrative data processing system 3500 in which aspects of the illustrative embodiments are implemented. Data processing system 3500 is an example of a computer, such as a server or client, in which computer usable code or instructions implementing the process for illustrative embodiments of the present invention are located. In some embodiments, the data processing system 3500 may be a server computing device.

In the depicted example, data processing system 3500 can employ a hub architecture including a north bridge and memory controller hub (NB/MCH) 3501 and south bridge and input/output (I/O) controller hub (SB/ICH) 3502. Processing unit 3503, main memory 3504, and graphics processor 3505 can be connected to the NB/MCH 3501. Graphics processor 3505 can be connected to the NB/MCH 3501 through, for example, an accelerated graphics port (AGP).

In the depicted example, a network adapter 3506 connects to the SB/ICH 3502. An audio adapter 3507, keyboard and mouse adapter 3508, modem 3509, read only memory (ROM) 3510, hard disk drive (HDD) 3511, optical drive (e.g., CD or DVD) 3512, universal serial bus (USB) ports and other communication ports 3513, and PCl/PCIe devices 3514 may connect to the SB/ICH 3502 through bus system 3516. PCl/PCIe devices 3514 may include Ethernet adapters, add-in cards, and PC cards for notebook computers. ROM 3510 may be, for example, a flash basic input/output system (BIOS). The HDD 3511 and optical drive 3512 can use an integrated drive electronics (IDE) or serial advanced technology attachment (SATA) interface. A super I/O (SIO) device 3515 can be connected to the SB/ICH 3502.

An operating system can run on processing unit 3503. The operating system can coordinate and provide control of various components within the data processing system 3500. As a client, the operating system can be a commercially available operating system. An object-oriented programming system, such as the Java™ programming system, may run in conjunction with the operating system and provide calls to the operating system from the object-oriented programs or applications executing on the data processing system 3500. As a server, the data processing system 3500 can be an IBM® eServer™ System p® running the Advanced Interactive Executive operating system or the Linux operating system. The data processing system 3500 can be a symmetric multiprocessor (SMP) system that can include a plurality of processors in the processing unit 3503. Alternatively, a single processor system may be employed.

Instructions for the operating system, the object-oriented programming system, and applications or programs are located on storage devices, such as the HDD 3511, and are loaded into the main memory 3504 for execution by the processing unit 3503. The processes for embodiments described herein can be performed by the processing unit 3503 using computer usable program code, which can be located in a memory such as, for example, main memory 3504, ROM 3510, or in one or more peripheral devices.

A bus system 3516 can be comprised of one or more busses. The bus system 3516 can be implemented using any type of communication fabric or architecture that can provide for a transfer of data between different components or devices attached to the fabric or architecture. A communication unit such as the modem 3509 or the network adapter 3506 can include one or more devices that can be used to transmit and receive data.

Those of ordinary skill in the art will appreciate that the hardware depicted in FIG. 35 may vary depending on the implementation. Other internal hardware or peripheral devices, such as flash memory, equivalent non-volatile memory, or optical disk drives may be used in addition to or in place of the hardware depicted. Moreover, the data processing system 3500 can take the form of any of a number of different data processing systems, including but not limited to, client computing devices, server computing devices, tablet computers, laptop computers, telephone or other communication devices, personal digital assistants, and the like. Essentially, data processing system 3500 can be any known or later developed data processing system without architectural limitation.

While various other circuits, circuitry or components may be utilized in information handling devices, with regard to smart phone and/or tablet-like circuitry 3600, an example illustrated in FIG. 36 includes a system on a chip design found for example in tablet or other mobile computing platforms. Software and processor(s) are combined in a single chip 3610. Processors comprise internal arithmetic units, registers, cache memory, busses, I/O ports, etc., as is well known in the art. Internal busses and the like depend on different vendors, but essentially all the peripheral devices (3620) may attach to a single chip 3610. The circuitry 3600 combines the processor, memory control, and I/O controller hub all into a single chip 3610. Also, systems 3600 of this type do not typically use SATA or PCI or LPC. Common interfaces, for example, include SDIO and I2C.

There are power management chip(s) 3630, e.g., a battery management unit, BMU, which manage power as supplied, for example, via a rechargeable battery 3640, which may be recharged by a connection to a power source (not shown). In at least one design, a single chip, such as 3610, is used to supply BIOS like functionality and DRAM memory.

System 3600 typically includes one or more of a WWAN transceiver 3650 and a WLAN transceiver 3660 for connecting to various networks, such as telecommunications networks and wireless Internet devices, e.g., access points. Additionally, devices 3620 are commonly included. System 3600 may include a touch screen 3670 for data input and display/rendering, e.g., including provisioning of a soft keyboard. System 3600 also typically includes various memory devices, for example flash memory 3680 and SDRAM 3690.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112(f) unless the element is expressly recited using the phrase “means for.”

Although the disclosure has been described with reference to exemplary embodiments, it is not limited thereto. Those skilled in the art will appreciate that numerous changes and modifications may be made to the embodiments described herein and that such changes and modifications may be made without departing from the true spirit of the disclosure. It is therefore intended that the appended claims be construed to cover all such equivalent variations as fall within the true spirit and scope of the disclosure.

What is claimed is:

1. A method for providing customer relationship management comprising:
obtaining, using a processor, remote traffic data for one or more merchant websites, the web traffic data comprising a customer count, a virtual sales count, and online customer based data;
receiving, using the processor, foot traffic data for one or more merchants comprising a retail customer count, a retail sales count, and customer based data, wherein the foot traffic data is obtained using at least one of user input and sensor data;
automatically determining, using the processor, one or more customer relationship management factors based on the web traffic and the foot traffic;
receiving, using the processor, one or more user inputs comprising a request for a portion of the one or more customer relationship management factors;
generating, using the processor, a customized user interface associated with the portion of the one or more customer relationship management factors;
displaying, within the customized user interface, a visual representation of the portion of the one or more customer relationship management factors.

2. The method of claim 1, wherein the online customer based data comprises at least one of: a geographic location, a bounce rate, a traffic source, an associated sales person, a target product, and demographic data of the customer.

3. The method of claim 1, wherein the customer based data comprises at least one of: a geographic location, a bounce rate, a referral source, an associated sales person, a target product, and demographic data of the customer.

4. The method of claim 1, wherein the remote traffic data comprises at least one of web traffic data and telephonic data.

5. The method of claim 1, wherein the one or more user inputs further comprise authentication information associated with the user.

6. The method of claim 5, wherein the authentication information is associated with an access level; and wherein access to the one or more customer relationship management factors is based on the access level.

7. The method of claim 1, further comprising generating, using the processor, a customer relationship management report comprising one or more report factors selected from the group consisting of: deflection rate, one or more opportunities, one or more sources, one or more merchants, one or more customers, one or more sales people, one or more target products, one or more geographic regions, one or more target product features, one or more target product categories, and temporal data.

8. The method of claim 7, wherein the customer relationship management report further comprises a comparison between a plurality of the one or more report factors.

9. The method of claim 1, wherein the customized user interface comprises one or more report factors selected from the group consisting of: deflection rate, one or more opportunities, one or more sources, one or more merchants, one or more customers, one or more sales people, one or more target products, one or more geographic regions, one or more target product features, one or more target product categories and temporal data.

10. The method of claim 9, wherein the customized user interface further comprises a comparison between a plurality of the one or more report factors.

11. A device for providing customer relationship management comprising:
a processor; and
a non-transitory, computer-readable storage medium in operable communication with the processing device, wherein the non-transitory, computer-readable storage medium contains one or more programming instructions that, when executed, cause the processing device to:
obtain, using the processor, remote traffic data for one or more merchant websites, the web traffic data comprising a customer count, a virtual sales count, and online customer based data;
receive, using the processor, foot traffic data for one or more merchants comprising a retail customer count, a retail sales count, and customer based data, wherein the foot traffic data is obtained using at least one of user input and sensor data;
automatically determine, using the processor, one or more customer relationship management factors based on the web traffic and the foot traffic;
receive, using the processor, one or more user inputs comprising a request for a portion of the one or more customer relationship management factors;
generate, using the processor, a customized user interface associated with the portion of the one or more customer relationship management factors;
display, within the customized user interface, a visual representation of the portion of the one or more customer relationship management factors.

12. The device of claim 11, wherein the online customer based data comprises at least one of: a geographic location, a bounce rate, a traffic source, an associated sales person, a target product, and demographic data of the customer.

13. The device of claim 11, wherein the customer based data comprises at least one of: a geographic location, a bounce rate, a referral source, an associated sales person, a target product, and demographic data of the customer.

14. The device of claim 11, wherein the remote traffic data comprises at least one of web traffic data and telephonic data.

15. The device of claim 11, wherein the one or more user inputs further comprise authentication information associated with the user.

16. The device of claim 15, wherein the authentication information is associated with an access level; and wherein access to the one or more customer relationship management factors is based on the access level.

17. The device of claim 11, further comprising generating, using the processor, a customer relationship management report comprising one or more report factors selected from the group consisting of: deflection rate, one or more opportunities, one or more sources, one or more merchants, one or more customers, one or more sales people, one or more target products, one or more geographic regions, one or more target product features, one or more target product categories, and temporal data.

18. The device of claim 17, wherein the customer relationship management report further comprises a comparison between a plurality of the one or more report factors.

19. The device of claim 11, wherein the customized user interface comprises one or more report factors selected from the group consisting of: deflection rate, one or more opportunities, one or more sources, one or more merchants, one or more customers, one or more sales people, one or more target products, one or more geographic regions, one or more target product features, one or more target product categories and temporal data.

20. The method of claim 19, wherein the customized user interface further comprises a comparison between a plurality of the one or more report factors.
